(19) United States
(12) Patent Application Publication
(10) Pub. No.: US 2026/0072511 A1
(43) Pub. Date: Mar. 12, 2026

(54) HAPTIC CONTROL FOR AUTOMOTIVE ENVIRONMENTS

(71) Applicant: Cirrus Logic International Semiconductor Ltd., Edinburgh (GB)

(72) Inventors: Adrian W. HILL, Walled Lake, MI (US); Jorge L. REYNAGA, Leander, TX (US); Stefan WILLIAMS, London (GB); Amir KARSHENAS, Welwyn Garden City (GB); Miguel A. SANCHEZ-RICO, Austin, TX (US)

(73) Assignee: Cirrus Logic International Semiconductor Ltd., Edinburgh (GB)

(21) Appl. No.: 19/385,586

(22) Filed: Nov. 11, 2025

Related U.S. Application Data
(63) Continuation-in-part of application No. 19/042,246, filed on Jan. 31, 2025.
(60) Provisional application No. 63/548,905, filed on Feb. 2, 2024.
(60) Provisional application No. 63/555,258, filed on Feb. 19, 2024.

(51) Int. Cl. G06F 3/01; B60R 16/023; G06F 3/16

(52) U.S. Cl. CPC G06F 3/016; B60R 16/023; G06F 3/16

(57) ABSTRACT

A control method is considered for use in controlling one or more transducers of an automobile, the control method comprising: generating, for a haptic event having a haptic output, an audio/visual control signal for at least one audio/visual transducer of the one or more transducers so that at least a corresponding audio or visual output accompanying the haptic output is a function of a level of ambient vibration in an operational environment of the one or more transducers, wherein the operational environment is an automotive environment.

### FIELD OF DISCLOSURE

The present disclosure relates to haptic control, in particular of a haptic actuator, for use in environments such as automotive environments. Control of audio/visual transducers is also considered. Use in an automotive environment may comprise use onboard a vehicle, for example.

### BACKGROUND

Haptic actuators or transducers, often referred to as vibrational actuators or transducers, find use in haptic applications. As is well known, haptic (or haptics) technology creates an experience of touch, or a tactile experience, by applying forces, vibrations, or motions to a user. Using a haptic actuator, forces may be applied to the user to give a haptic experience (for example, haptic feedback, haptic alerts or haptic augmentation). The haptic experience may accompany and/or enhance another user experience, such as an audio or visual experience (e.g. haptic-augmented audio or haptic-augmented video), or may merely provide the user with tactile information, for example concerning the status of an ongoing process (e.g. in the case of a haptic human-machine interface, HMI).

Available transducers considered herein also include, along with haptic transducers (haptic actuators), audio/visual transducers. An audio/visual transducer will be understood here to be an audio and/or visual transducer, and thus operable to generate an audio and/or visual output.

Haptic actuators are increasingly being employed in environments such as automotive environments. It is desirable to improve haptic control (and consequently haptic experiences) in such environments, and to provide corresponding improved haptic systems, haptic control systems and related methods and computer programs.

### SUMMARY

According to a first aspect of the present disclosure, there is provided an automotive haptic control system for controlling a haptic output of a haptic actuator of an automobile, the haptic control system comprising: a haptic controller configured to: obtain vibrational information indicative of a level of ambient vibration in an operational environment of the haptic actuator, wherein the operational environment is an automotive environment; determine the level of ambient vibration from the vibrational information; and generate a haptic control signal for use in controlling the haptic output of the haptic actuator, wherein a value of the haptic control signal is a function of the level of ambient vibration.

According to a second aspect of the present disclosure, there is provided an automotive haptic system comprising: the automotive haptic control system of the first aspect of the present disclosure; and the haptic actuator.

According to a third aspect of the present disclosure, there is provided an automobile comprising the automotive haptic control system of the first aspect of the present disclosure or the automotive haptic system of the second aspect of the present disclosure.

According to a fourth aspect of the present disclosure, there is provided automotive haptic control method for controlling a haptic output of a haptic actuator of an automobile, the haptic control method comprising: obtaining vibrational information indicative of a level of ambient vibration in an operational environment of the haptic actuator; determining the level of ambient vibration from the vibrational information; and generating a haptic control signal for use in controlling the haptic output of the haptic actuator, wherein a value of the haptic control signal is a function of the level of ambient vibration.

According to a fifth aspect of the present disclosure, there is provided an automotive haptic control computer program which, when executed on a computer of a haptic control system of an automobile, causes the automotive haptic control system to carry out the automotive haptic control method of the fourth aspect of the present disclosure.

According to a sixth aspect of the present disclosure, there is provided a computer-readable storage medium having the automotive haptic control computer program of the fifth aspect of the present disclosure stored thereon.

According to a seventh aspect of the present disclosure, there is provided an automotive haptic controller for controlling a haptic signal, the haptic signal for use in driving a haptic actuator of an automobile, the automotive haptic controller configured to: obtain vibrational information indicative of a level of ambient vibration in an operational environment of the haptic actuator; determine the level of ambient vibration from the vibrational information; and generate the haptic control signal, wherein a value of the haptic control signal is a function of the level of ambient vibration.

According to an eighth aspect of the present disclosure, there is provided a method of controlling a haptic actuator of an automobile, the method comprising: obtaining vibrational information indicative of a level of ambient vibration in an operational environment of the haptic actuator; determining the level of ambient vibration from the vibrational information; and controlling the haptic actuator, wherein a drive signal of the haptic actuator is a function of the level of ambient vibration.

According to a ninth aspect of the present disclosure, there is provided an automotive haptic system, comprising: a haptic actuator; and a haptic control system configured to: obtain vibrational information indicative of a level of ambient vibration in an operational environment of the haptic actuator; determine the level of ambient vibration from the vibrational information; and control the haptic actuator, wherein a drive signal of the haptic actuator is a function of the level of ambient vibration.

According to a tenth aspect of the present disclosure, there is provided a control method for use in controlling one or more transducers of an automobile, comprising: generating, for a haptic event having a haptic output, an audio/visual control signal for at least one audio/visual transducer of the one or more transducers so that at least a corresponding audio or visual output accompanying the haptic output is a function of a level of ambient vibration in an operational environment of the one or more transducers, wherein the operational environment is an automotive environment.

According to an eleventh aspect of the present disclosure, there is provided a control method for use in controlling a haptic transducer of an automobile, comprising: generating, for a haptic event having a haptic output generated by the haptic transducer, a haptic control signal for the haptic transducer so that a duration of the haptic output is a function of a level of ambient vibration in an operational environment of the one or more transducers, wherein the operational environment is an automotive environment.

According to a twelfth aspect of the present disclosure, there is provided a control method for use in controlling a haptic transducer of an automobile, comprising: generating, for a haptic event having a haptic output generated by the haptic transducer, a haptic control signal for the haptic transducer so that a frequency of the haptic output but not a level of the haptic output is a function of a level of ambient vibration in an operational environment of the one or more transducers, wherein the operational environment is an automotive environment.

According to a thirteenth aspect of the present disclosure, there is provided a transducer control system or transducer controller configured to carry out the method of any of tenth to twelfth aspects.

According to a fourteenth aspect of the present disclosure, there is provided a transducer system for use in controlling one or more transducers of an automobile, the transducer system comprising: the transducer control system or the transducer controller of the thirteenth aspect; and the one or more transducers.

According to a fifteenth aspect of the present disclosure, there is provided an automobile comprising the transducer control system or the transducer controller of the thirteenth aspect or the transducer system of the fourteenth aspect.

According to a sixteenth aspect of the present disclosure, there is provided a transducer control computer program which, when executed on a computer of a transducer control system of an automobile, causes the transducer control system to carry out the control method of any of the tenth to twelfth aspects.

According to a seventeenth aspect of the present disclosure, there is provided a computer-readable storage medium having the transducer control computer program of the sixteenth aspect stored thereon.

Corresponding apparatus/device aspects, method aspects, computer program aspects and storage medium aspects are envisaged. Features of one aspect may be applied to another and vice versa. Further aspects are set out at the end of the description.

### BRIEF DESCRIPTION OF THE DRAWINGS

Reference will now be made, by way of example only, to the accompanying drawings, of which:

FIG. 1 is a schematic diagram of an example automotive environment, for use in better understanding arrangements of the present disclosure;

FIG. 2 is a schematic diagram of a haptic control method of controlling a haptic output of a haptic actuator;

FIGS. 3 and 4 are schematic diagrams of example haptic systems;

FIG. 5 is a schematic diagram useful for understanding that a haptic actuator may be implemented as a plurality of haptic actuators;

FIGS. 6 to 10 are schematic diagrams of further example haptic systems;

FIGS. 11A to 11F are schematic diagrams useful for better understanding that elements of a haptic system may be distributed across the operational environment;

FIG. 12 is a diagram useful for understanding example types of operational environment.

FIG. 13 is a schematic diagram of an example automotive environment, for use in better understanding further arrangements of the present disclosure;

FIG. 14 is a schematic diagram of a control method for use in controlling the one or more transducers;

FIGS. 15 and 16 are schematic diagrams of example transducer systems;

FIGS. 17A to 17F are tables useful for understanding potential ways in which haptic and/or audio/visual outputs may be controlled; and

FIG. 18 is a table similar to those of FIGS. 17A to 17F useful for understanding that a range of factors may be controlled.

### DETAILED DESCRIPTION

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

As mentioned above, haptic actuators are increasingly being employed in environments such as automotive environments. For example, a haptic-augmented video or audio experience, or haptic alerts, may be provided to a user (driver or passenger). In such environments there may be considerable ambient vibration, and the ambient vibration may affect the user haptic experience (for example, the perceived strength or ‘volume’ of any haptic experience, such as haptic feedback, haptic alerts or haptic augmentation).

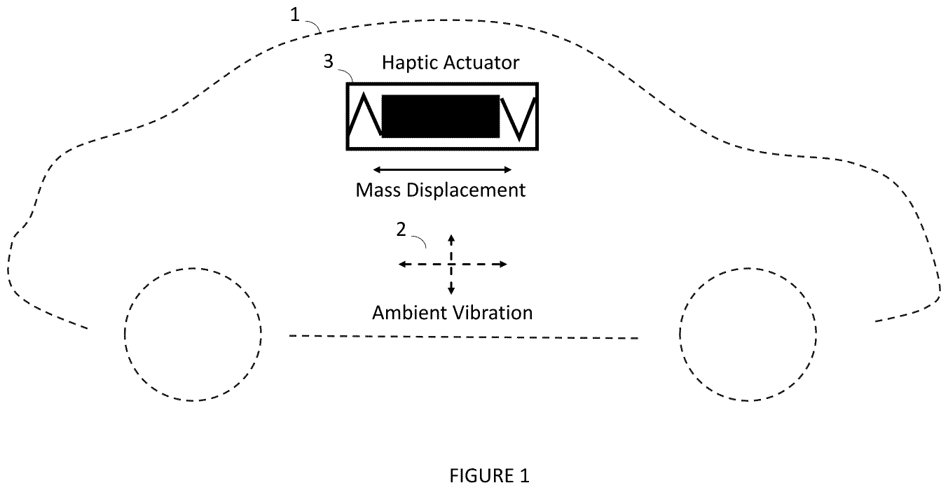

FIG. 1 is a schematic diagram of an example automotive environment, for use in better understanding arrangements of the present disclosure. The example automotive environment comprises an automobile 1, in this case a vehicle such as a car, and this will be carried forward as a running example.

As indicated, it may be expected that considerable or substantial ambient vibration 2 may be present in such an automotive environment. The ambient vibration 2 may be considerable or substantial in that it is non-negligible from the point of view of a user, affecting the haptic experience. The user in this context may use a system or device of the automobile 1 which provides the user with haptic feedback via a haptic actuator 3 which is also schematically shown.

As a simplified example, the haptic actuator 3 may be controlled to provide haptic feedback by vibration of a mass (represented by a solid black rectangle) along a mass displacement axis as indicated, the orientation of this axis dependent on the actuator type or configuration and how it is mounted within the automobile 1. A component of the ambient vibration 2 may be experienced along this mass displacement axis, although of course the ambient vibration may have a component along any axis (or components along any axes) defined in 3D space depending on the application.

The level of ambient vibration 2 may be equal to or higher than a threshold level of ambient vibration, and accordingly may detrimentally impact a haptic experience provided via the haptic actuator 3. For example, if the strength of the haptic feedback is set to be relatively low and there is relatively high ambient vibration, the haptic feedback may appear weak to the user or even imperceptible. Conversely, if the strength of the haptic feedback is set to be relatively high and there is relatively low ambient vibration, the haptic feedback may appear strong to the user, perhaps alarmingly or uncomfortably so or both. The haptic feedback may be particularly alarming if the strength of the haptic feedback is set to be relatively high and the ambient vibration quickly or suddenly subsides.

The inventors have envisaged that it is desirable to control the haptic actuator 3, or the haptic output of the haptic actuator 3, based on the level of ambient vibration in the operational environment of the haptic actuator 3.

In an example, ambient vibration may be measured along the axis of operation of the haptic actuator 3 (along which haptics vibration may be actuated), for example by the haptic actuator 3 itself. Typically, such actuators only operate in one axis whereas a vehicle in motion will usually have ambient vibration components in three (mutually orthogonal) axes. In some arrangements, vibration along the (measured) haptic actuator 3 axis can be sensed and vibration tangential to that might not be sensed, and this may be an acceptable arrangement as compensation applied to the driving of the haptic actuator 3 in this example will also be applied only in the axis of actuation and sensitivity of a single axis actuator. More generally, however, multiple haptic actuators may be provided (with actuation axes in different directions), or haptic actuators may be provided which actuate in more than one axis, and vibration sensing may also be provided along axes in different directions (by virtue of the haptic actuators and/or other vibration sensors). As such, the techniques considered herein may be applied to single/multi axes of sensing/vibration/actuation scenarios, and the present disclosure will be understood accordingly.

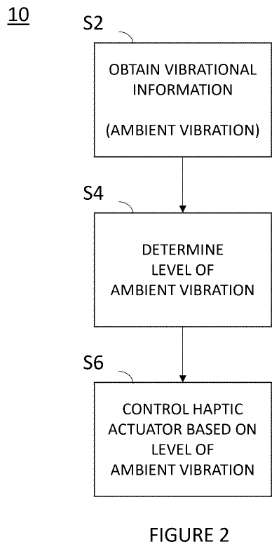

FIG. 2 is a schematic diagram of a haptic control method 10 of controlling a haptic output of a haptic actuator, comprising steps S2, S4 and S6, for use in operational environments such as automotive environments. The haptic control method 10 may be referred to as an automotive haptic control method in the running example.

Step S2 comprises obtaining vibrational information indicative of a level of ambient vibration in the operational environment of the haptic actuator 3, and step S4 comprises determining (e.g. calculating) the level of ambient vibration from the vibrational information. Step S6 comprises controlling the haptic actuator 3 based on the (determined) level of ambient vibration.

Steps S2 and S4 may occur prior to or at least partly in parallel with step S6, with the arrows between steps S2, S4 and S6 in FIG. 2 indicating the dependency of step S6 on the vibrational information obtained in step S2.

In some arrangements, step S6 may comprise generating a haptic control signal for use in controlling the haptic output of the haptic actuator 3, wherein a value of the haptic control signal is a function of the level of ambient vibration. A haptic drive signal, used to drive the haptic actuator 3, may be generated based on the haptic control signal. In some arrangements, step S6 may comprise generating, based on the (determined) level of ambient vibration, a haptic drive signal for use in driving the haptic actuator 3, wherein a value of the haptic drive signal is a function of the (determined) level of ambient vibration. The value of the haptic control signal and/or haptic drive signal may be taken here to be an average or running average of the (i.e. its) signal magnitude or peak value or peak-to-peak value or DC level.

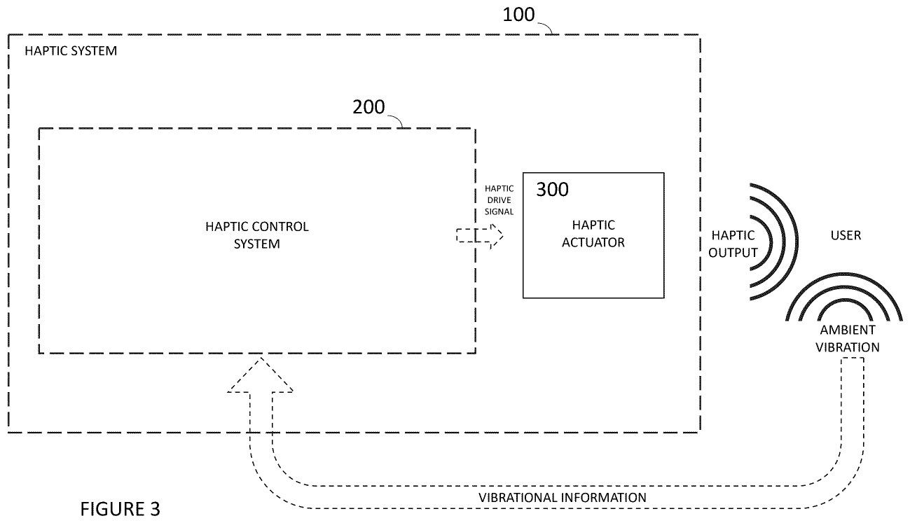

FIG. 3 is a schematic diagram of a haptic system 100 which comprises a haptic control system 200 and a haptic actuator 300, and which is configured to carry out the haptic control method 10. The haptic system 100 may be part or all of the automobile 1 of FIG. 1 and similarly the haptic actuator 300 may be part or all of the haptic actuator 3 of FIG. 1.

As indicated, in use the haptic actuator 300 is configured to provide a haptic output to provide the user with a haptic experience. However, the user is also subject to ambient vibration in the operational environment of the haptic actuator 300. The ambient vibration may be understood as comprising background vibration, vibrational noise (which may include audible noise) or vibrational acceleration.

The haptic control system 200 is configured to obtain vibrational information indicative of a level of ambient vibration in an operational environment of the haptic actuator 300. This vibrational information may be obtained from any of a number of information sources, and these information sources may correspond to an extent to vibration sources in the context of automobile 1, as will be considered in more detail later.

In general, the vibrational information may contain information from which the ambient vibration may be estimated and/or information from one or more vibrational sensors located to sense the ambient vibration. Such sensors may comprise the haptic actuator 300 itself and/or other sensors operable to measure respective aspects of the ambient vibration. Example sensors (which may be part of the haptic system 100 or haptic control system 200) include microphones, accelerometers, inertial measurement units, motion sensors, speakers, piezoelectric sensors, MEMS (microelectromechanical systems) vibration sensors, force sensors, wheel speed sensors, suspension sensors, and motor control sensors (consider feedback parameters indicating vibration derived from motor control, such as a traction motor in an electric vehicle which can be using position sensors or commutation paraments like back electromotive force, bEMF). At least part of the vibrational information may comprise feedback information provided by the haptic actuator 300 itself.

The haptic control system 200 is configured to control the haptic actuator 300 with a haptic drive signal as indicated, based on the vibrational information. By virtue of this control, the drive signal of the haptic actuator is a function of the vibrational information and/or of the level of ambient vibration.

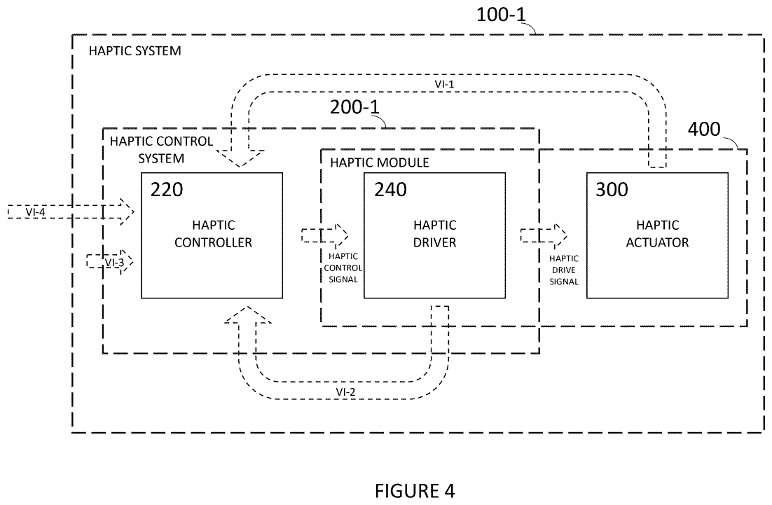

FIG. 4 is a schematic diagram of a haptic system 100-1, being a detailed implementation of the haptic system 100 of FIG. 3. The haptic system 100-1 comprises a haptic control system 200-1 and the haptic actuator 300. The haptic control system 200-1 is a detailed implementation of the haptic control system 200 of FIG. 3. Continuing the running example, the haptic system 100-1 may be part or all of the automobile 1 of FIG. 1.

The haptic control system 200-1 comprises a haptic controller 220 and a haptic driver 240. The haptic controller 220 is configured to generate (and output) a haptic control signal and the haptic driver 240 is configured to generate (and output) the haptic drive signal based on the haptic control signal. Such systems may be provided as haptic-enabled components and devices. Related methods, such as method 10, computer programs and storage media comprising such computer programs are also envisaged.

The haptic system 100-1 may comprise elements other than the haptic control system 200-1 and the haptic actuator 300, for example one or more sensors as mentioned earlier. In some arrangements, one or more such sensors may form part of the haptic control system 200-1.

The haptic control system 200-1, the haptic controller 220 and/or the haptic driver 240 may be implemented as digital or analogue circuitry, in hardware or in software running on a processor, or in any combination of these. Such functionality may include any system, device, or apparatus configured to interpret and/or execute program instructions or code and/or process data, and may include, without limitation a processor, microprocessor, microcontroller, digital signal processor (DSP), application specific integrated circuit (ASIC), FPGA (Field Programmable Gate Array) or any other digital or analogue circuitry configured to interpret and/or execute program instructions and/or process data. Thus, the code may comprise program code or microcode or, for example, code for setting up or controlling an ASIC or FPGA. The code may also comprise code for dynamically configuring re-configurable apparatus such as re-programmable logic gate arrays. Similarly, the code may comprise code for a hardware description language such as Verilog™ or VHDL. As the skilled person will appreciate, the code may be distributed between a plurality of coupled components in communication with one another. Where appropriate, such aspects may also be implemented using code running on a field-(re) programmable analogue array or similar device in order to configure analogue hardware. Processor control code for execution may be provided on a non-volatile carrier medium such as a disk, CD- or DVD-ROM, programmed memory such as read only memory (Firmware), or on a data carrier such as an optical or electrical signal carrier. The haptic control system 200-1, the haptic controller 220 and/or the haptic driver 240 (or control circuitry thereof) may be provided as, or as part of, an integrated circuit (IC) such as an IC chip.

The haptic actuator 300 (or haptic transducer, or more simply, actuator or transducer) may be or comprise an LRA (linear resonant actuator) and/or a VCM (voice coil motor) and/or an ERM (eccentric rotating-mass motor), and these are of course just examples. More generally, haptic actuators may comprise electromagnetic (e.g. ERM or LRA), electrostatic, piezoelectric or electrostrictive actuators. The haptic actuator 300 may be implemented as a plurality of actual actuators (which may be referred to as sub-actuators or component actuators) in some arrangements.

The haptic system 100-1, haptic control system 200-1, the haptic controller 220 and/or the haptic driver 240 may be housed within an enclosure. The haptic system 100-1, haptic control system 200-1 and/or the haptic driver 240 may include any system, module, component, device, or apparatus configured to drive the haptic actuator 300 with the haptic drive signal. For example, haptic system 100-1, haptic control system 200-1 and/or the haptic driver 240 may be implemented in a component of the automobile 1 such as a switch pack (as considered in more detail later), a control interface (such as a dashboard, steering wheel or gear stick), an entertainment or information system, or an item of furniture (such as a driver seat, head rest or armrest), any of which may be provided with the haptic actuator 300. For example, a driver seat may provide a haptic experience to the (human) driver, in the form of a haptic alert or augmented audio (a haptic experience provided together with an audio experience).

The haptic controller 220 is configured to obtain vibrational information indicative of the level of ambient vibration, determine (e.g. calculate) the level of ambient vibration from the vibrational information, and generate the haptic control signal (for use in controlling the haptic output of the haptic actuator 300), wherein a value of the haptic control signal is a function of the (determined) level of ambient vibration. The “value” of the haptic control signal may be, or comprise, a level or DC component of the haptic control signal, including an average or running average value.

The level of ambient vibration may comprise a DC component or value of the ambient variation. The level of ambient vibration may be considered a volume or strength or intensity or power level of the ambient vibration, comparable to a volume or strength or intensity or power level of audible sound, for example. For example, the vibrational information may comprise or be based on a measurement of an instantaneous value or an average or running average of a magnitude, amplitude, peak value, peak-to-peak value, intensity, power or strength or volume, or a DC component thereof, of the ambient vibration.

The determination of the level of ambient vibration from the vibrational information may therefore depend on the format of the vibrational information. At one extreme, where the level of ambient vibration is directly expressed in the vibrational information, the determination may comprise simply extracting or reading that level of ambient vibration from the vibrational information. For example, the vibrational information may simply express the level of ambient vibration as a value (e.g. as a digital value of digital vibrational information), for example in the range 1 to 10, and the determination may comprise extracting or reading this value. At another extreme, where the vibrational information is effectively a waveform corresponding to vibrational sensor data or the like, the determination may comprise finding or calculating a DC component or an average or running average of a magnitude, amplitude, peak value, peak-to-peak value, intensity, power or strength, or a DC component thereof, of the vibrational information, and representing this (e.g. by normalisation) as a value, for example in the range 1 to 10.

The value of the haptic control signal may be set based on the level of ambient vibration, and the setting of the value of the haptic control signal may similarly depend on the format of the haptic control signal. At one extreme, where the value of the haptic control signal is directly expressed by the haptic control signal (e.g. by its magnitude, or as a digital value), the setting of the value of the haptic control signal may comprise simply setting that value. For example, the haptic control signal may be a digital signal whose digital value is set, for example in the range 1 to 10. At another extreme, where the haptic control signal is effectively a waveform such as a sinusoidal signal, the setting of the value of the haptic control signal may comprise controlling or configuring the sinusoidal signal (e.g. by controlling parameters of the sinusoidal signal) so that its DC component or an average or running average of a magnitude, amplitude, peak value, peak-to-peak value, intensity, power or strength, or a DC component thereof, expresses the value of the haptic control signal.

The haptic output may be a discrete haptic output having a duration, such as a pulse or other time-limited waveform. The haptic controller 220 may be configured to generate the haptic control signal such that its value is substantially constant for (the duration of) the discrete haptic output or is adjusted relatively slowly (for example over a period of milliseconds, tens or hundreds of milliseconds, or one or more seconds) over the duration of the discrete haptic output. The discrete haptic output may for example last for milliseconds, tens or hundreds of milliseconds, or one or more seconds. The discrete haptic output may for example last for 0.5 to 1 seconds. In other situations, the haptic output may comprise a series of discrete haptic outputs each having a duration, and the haptic controller 220 may be configured to generate the haptic control signal such that its value is substantially constant for (the duration of) each discrete haptic output but different for different discrete haptic outputs, for example when the level of ambient vibration is different for different discrete haptic outputs. Thus, as the level of ambient vibration (ambient noise) rises during the haptic output it may be that the value of the haptic control signal also rises so that the series of discrete haptic outputs get stronger. For example, the level of ambient vibration expressed as a value in a range 1 to 10 may be 4 then 5, then 6 for a series of three discrete haptic outputs, and the haptic control signal may be assigned the value 50 then 70 then 80 in range 1 to 100 for those three discrete haptic outputs, respectively. That is, the haptic control signal may have a stepped waveform or a (slowly) varying waveform.

As mentioned earlier, the vibrational information may contain information from which the ambient vibration may be estimated and/or information from one or more vibrational sensors located to sense the ambient vibration.

The ambient vibration may emanate from any of a number of vibration sources. For example, the ambient vibration may emanate from an engine or electric motor of the automobile 1, and the level of this ambient vibration may be dependent on the level of power output of the engine or electric motor (e.g. idling vs. accelerating). As another example, the ambient vibration may emanate from the interaction of the automobile 1 with its surroundings, for example with a road surface or with the surrounding air or with elements of the weather. Ambient vibration emanating from interaction with the road surface may depend on the type of road surface (e.g. smooth freeway vs rough track) and the speed at which the automobile 1 is travelling on that road surface. Ambient vibration emanating from interaction with the surrounding air may depend on the speed at which the automobile 1 is travelling, and for example whether a window or sunroof is open or partially open. Ambient vibration emanating from interaction with elements of the weather may depend on the current weather (e.g. heavy rain vs. no rain) and for example whether a window or sunroof is open or partially open. As another example, the ambient vibration may emanate from the passenger interior of the automobile 1, for example from an audio system of the automobile 1, or for example from the operation of windscreen wipers.

Where the ambient vibration emanates from an engine or electric motor of the automobile 1, the level of this ambient vibration may be estimated based on the power level of the engine or electric motor and/or measured by a sensor. As another example, where the ambient vibration emanates from the interaction of the automobile 1 with a road surface, the level of this ambient vibration may be estimated based on the location of the vehicle (e.g. based on GPS data) and/or measured by a sensor. Where the ambient vibration emanates from the interaction of the automobile 1 with elements of the weather, the level of this ambient vibration may be estimated based on weather data (e.g. the current weather or a weather forecast) and/or measured by a sensor. Where the ambient vibration emanates from an audio system of the automobile 1, the level of this ambient vibration may be estimated based on entertainment-system data (e.g. the current status of the audio system) and/or measured by a sensor. These are of course examples.

The vibrational information may thus comprise, or be based on, a measurement of the level of ambient vibration, for example based on a sensor signal. Where the haptic actuator 300 acts as such a sensor, at least part of the vibrational information may be provided to the haptic controller 220 from the haptic actuator 300 and/or from the haptic driver 240, as indicated by arrows VI-1 and VI-2, respectively. Put another way, the vibrational information may comprise feedback information based on a feedback signal from the haptic actuator 300. The feedback signal may be indicative of a current drawn by the haptic actuator 300 and/or a voltage across the haptic actuator 300.

The haptic system 100-1 may of course comprise one or more other sensors capable of sensing the ambient vibration, as mentioned earlier, in which case at least part of the vibrational information may be provided to the haptic controller 220 from those sensors within the haptic system 100-1, as indicated by arrow VI-3. Put another way, the vibrational information may comprise sensor information based on a sensor signal from a vibration sensor other than the haptic actuator 300.

The vibrational information may comprise, or be based on, an estimation of the level of ambient vibration, for example based on contextual data or information such as location or movement of the automobile 1, again as mentioned earlier. Where the haptic system 100-1 is configured to provide such contextual data (e.g. the haptic system 100-1 may comprise an in-vehicle entertainment system or engine-control system of the automobile 1), at least part of the vibrational information may be provided to the haptic controller 220 from an information source within the haptic system, as indicated by arrow VI-3. Where a source of such contextual data exists outside the haptic system 100-1 (e.g. a GPS system may provide location and/or velocity data, or a weather service may provide weather data), at least part of the vibrational information may be provided to the haptic controller 220 from an information source outside or external to the haptic system 100-1, as indicated by arrow VI-4. That is, the vibrational information may comprise external information, indicative of the ambient vibration, from an external data source. As another example, the vibrational information may comprise status information, indicative of the status of at least one vibration source (e.g. a car engine), optionally other than the haptic actuator 300, operable to contribute to the ambient vibration, or at least one vibration affecter (e.g. a car window), operable to affect the ambient vibration (e.g. without itself creating that vibration). As another example, the vibrational information may comprise environmental information, indicative of an aspect of the operational environment of the haptic actuator which affects the ambient vibration (e.g. location, speed, acceleration).

The vibrational information may comprise prior vibrational information, indicative of the level of ambient vibration prior to the haptic output. For example, the prior vibrational information may be obtained prior to the haptic output. The vibrational information may comprise current vibrational information, indicative of the level of ambient vibration during the haptic output. For example, the current vibrational information may be obtained during the haptic output.

The haptic controller 220 may be configured to obtain the vibrational information over time (continuously, intermittently, regularly or irregularly) to track the ambient vibration. In some arrangements, the haptic controller 220 may be model-based—the haptic controller 220 may be configured to update a model (representative of the operational environment and/or of the level of ambient vibration) based on the obtained vibrational information, and to generate the haptic control signal based on the model.

The haptic controller 220 may be configured to control the value of the haptic control signal so that it at least partly tracks (or compensates for or responds to) a change in the vibrational information indicative of a change in the level of ambient vibration. For example, the haptic controller 220 may be configured to adjust the value of the haptic control signal based on the level of ambient vibration. In some arrangements, the haptic controller 220 may adjust the value of the haptic control signal during the haptic output. For context, a higher value of the haptic control signal may correspond to a higher volume or level of the haptic output and a lower value of the haptic control signal may correspond to a lower volume or level of the haptic output (although in some arrangements the opposite may be true).

In some arrangements, the control of the value of the haptic control signal may comprise adjusting the value of the haptic control signal to tend to keep a difference or ratio between the value of the haptic control signal and the level of ambient vibration above a threshold level, within a target range and/or substantially constant. In some arrangements, the control of the value of the haptic control signal may comprise raising the value of the haptic control signal when the level of ambient vibration (indicated by the vibrational information) increases and/or lowering the value of the haptic control signal when the level of ambient vibration decreases.

In some arrangements, the control of the value of the haptic control signal may comprise setting the value of the haptic control signal at a first level when the vibrational information is indicative of a first level of ambient vibration and setting the value of the haptic control signal at a second level, higher than the first level, when the vibrational information is indicative of a second level of ambient vibration, higher than the first level of ambient vibration. In some arrangements, the control of the value of the haptic control signal may comprise controlling the value of the haptic control signal so that the value of the haptic control signal at least partly tracks the level of ambient vibration.

The haptic controller 220 may be configured to determine when it is worthwhile controlling the haptic control signal based on the ambient vibration. For example, in some cases the ambient vibration may be relatively weak or negligible from the point of view of its effect on the user. The haptic controller 220 may in this respect be configured to compare the level of ambient vibration indicated by the vibrational information with a threshold level of ambient vibration. Such a threshold level may be set, or updated or learnt over time, to distinguish between cases where it is worthwhile controlling the haptic control signal based on the ambient vibration and cases where it is not. The haptic controller 220 may be configured to adjust the value of the haptic control signal when the level of ambient vibration is higher than or equal to the threshold level of ambient vibration. Conversely, the haptic controller 220 may be configured not to adjust the value of the haptic control signal when the level of ambient is lower than the threshold level of ambient vibration.

The haptic controller 220 may be configured to control the haptic control signal differently in different circumstances. Put another way, the haptic controller may be configured to adjust or set the function of the level of ambient vibration based one or more operational factors, such as one or more user-related, usage-related or environmental factors.

For example, how the haptic controller 220 controls the haptic control signal may be dependent on at least one of: a history of haptic outputs; a history of detected user responses to haptic outputs; a user setting or system setting; a categorisation of the haptic output, optionally wherein the haptic output is configured to have a high-priority categorisation, a low-priority categorisation, a safety-related categorisation, an emergency categorisation, an alert categorisation (e.g. a haptic alert, such as a lane control alert) and/or an informational categorisation; and information defining the operational environment of the haptic actuator (e.g. a characteristic of the user (e.g. their weight or age or a hearing (dis) ability status), time of day, location, ambient temperature, ambient audible noise level, estimated user distraction level, type of automobile, speed, and/or acceleration).

Factors of the control provided by the haptic controller 220 which may be adjusted or set dependent on such circumstances/factors may comprise at least one of: an upper limit on the value of the haptic control signal; a lower limit on the value of the haptic control signal; a relationship between the level of ambient vibration indicated by the vibrational information and the value of the haptic control signal; and a rate at which the value of the haptic control signal is adjusted.

Looking back at FIG. 4, the haptic driver 240 is configured to drive the haptic actuator with the haptic drive signal based on the haptic control signal. The haptic driver 240 is configured to control a level of the haptic drive signal based on the value of the haptic control signal.

The level of the haptic drive signal may comprise a DC component of the haptic drive signal, such as of a power level or peak-to-peak value of the haptic drive signal. The haptic drive signal may be a sinusoidal signal. The level of the haptic drive signal may be taken to be an instantaneous value or an average or running average of a magnitude, amplitude, peak value, peak-to-peak value, intensity, power, volume level or strength, or a DC component thereof, of the haptic drive signal.

Controlling the level of the haptic drive signal may comprise controlling a gain, wherein the haptic driver is configured to apply the gain to a reference signal (or target signal) to generate the haptic drive signal. Controlling the level of the haptic drive signal may comprise controlling a level of amplification applied to the haptic drive signal and/or to the reference signal to generate the haptic drive signal. Controlling the level of the haptic drive signal may comprise controlling a power level of an amplifier used to amplify the haptic drive signal or a signal derived therefrom. Controlling the level of the haptic drive signal may comprise controlling a power level of the haptic actuator 300. Controlling the level of the haptic drive signal may comprise controlling an instantaneous value or an average or running average of a power level or peak-to-peak value of the haptic drive signal.

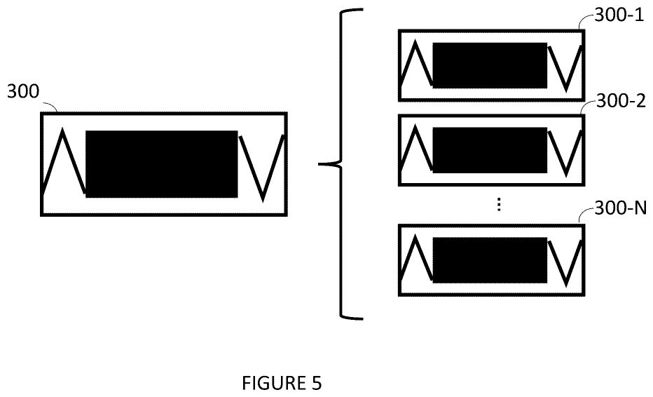

Controlling the level of the haptic drive signal may comprise controlling a number of haptic actuators driven by the haptic drive signal, wherein the haptic actuator 300 comprises a plurality of haptic actuators. In this respect, reference is made to FIG. 5, which is a schematic diagram useful for understanding that the haptic actuator 300 may be implemented as N (discrete or separate) haptic actuators 300-1 to 300-N, where integer N satisfies N≥2. For example, controlling the level of the haptic drive signal may comprise controlling which of the N haptic actuators 300-1 to 300-N are driven (such as deciding which haptic actuators are provided with, or not provided with, power), rather than controlling a power level of a drive signal provided to an individual one of the N haptic actuators 300-1 to 300-N.

Returning to FIG. 4, the haptic driver 240 may be configured to receive a feedback signal (not shown) from the haptic actuator 300, wherein the vibrational information (see arrow VI-2) is based on the feedback signal. Such a feedback signal may be, as mentioned earlier, indicative of a current drawn by the haptic actuator and/or a voltage across the haptic actuator 300. Of course, such a feedback signal may be provided directly to the haptic controller 220 as mentioned earlier (see arrow VI-1).

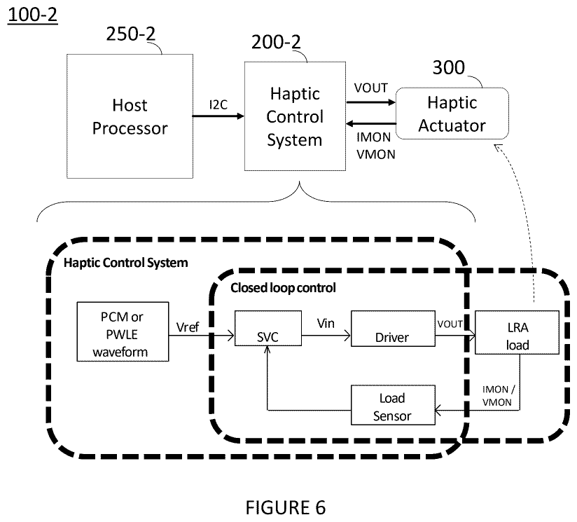

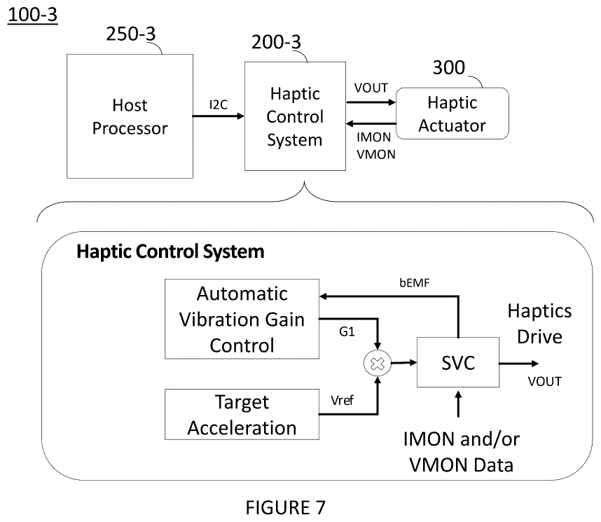

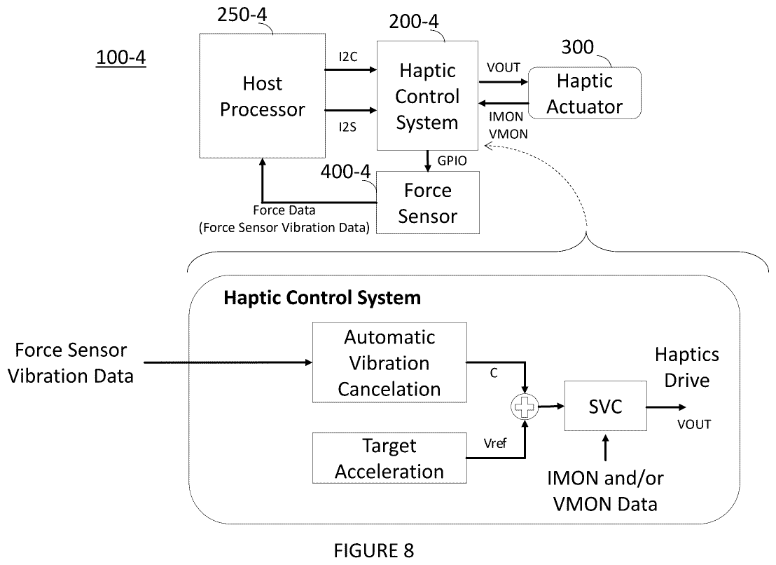

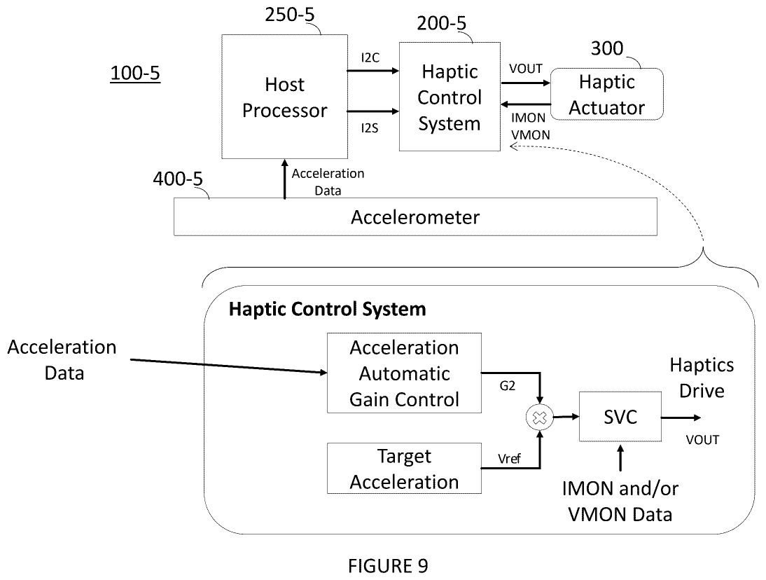

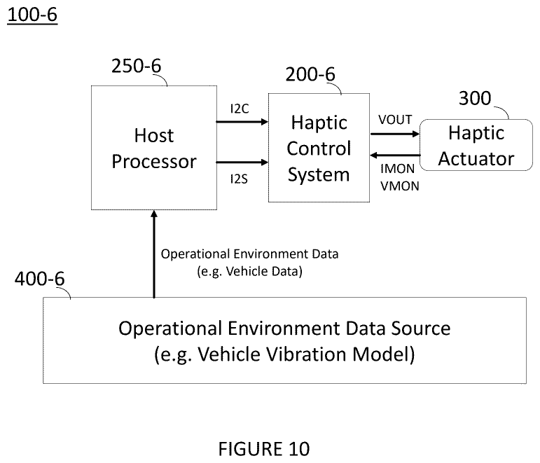

Reference will now be made to FIGS. 6 to 10, which present further detailed implementations. In overview, the implementation of FIG. 6 considers a Sensorless Velocity Control (SVC) technique, the implementation of FIG. 7 considers an SVC technique in combination with an Automatic Vibration Gain Control (AVGC) technique, the implementation of FIG. 8 considers an SVC technique in combination with an Automatic Vibration Cancelation (AVC) technique, the implementation of FIG. 9 considers an SVC technique in combination with an Automatic Acceleration Gain Control (AAGC) technique, and the implementation of FIG. 10 considers a situation where any of the above techniques may be employed, alone or in combination, and also where operational environment data is available from an operational environment data source.

FIG. 6 is a schematic diagram of a haptic system 100-2, being a detailed implementation of the haptic systems 100 of FIG. 3 and 100-1 of FIG. 4.

The haptic system 100-2 comprises a haptic control system 200-2 and the haptic actuator 300. The haptic control system 200-2 is a detailed implementation of the haptic control system 200-1 of FIG. 4. Continuing the running example, the haptic system 100-2 may be part or all of the automobile 1 of FIG. 1.

Also shown is a host processor 250-2, which may be considered part of the haptic system 100-2 or external to the haptic system 100-2, depending on the application. The host processor 250-2 is communicatively coupled to the haptic control system 200-2, in the example arrangement via an I2C (Inter-Integrated Circuit) serial communication bus. In some arrangements, the host processor 250-2 may be considered part of the haptic control system 200-2, for example corresponding to part or all of the haptic controller 220 of FIG. 4.

The haptic system 100-2 employs an SVC technique, in that the haptic actuator 300 is controlled in response to ambient vibration without needing external sensors (i.e. beyond the haptic actuator 300 itself) to monitor the effects of external vibration (ambient vibration), such as vehicle/car vibration in the running example. Of course, such external sensors may be provided (and provide vibrational information) in addition to the haptic actuator 300 itself, as discussed earlier. Recall from FIG. 1 that a component of the ambient vibration may occur along the mass displacement axis and thus affect the operation of the haptic actuator 300.

As indicated, the haptic control system 200-2 controls the haptic actuator 300 with an output voltage signal VOUT (haptic drive signal) and receives output monitored current IMON and output monitored voltage VMON signals, or at least one of them, as a feedback signal from the haptic actuator 300. The IMON signal is indicative of a current drawn by the haptic actuator 300 and the VMON signal is indicative of a voltage across the haptic actuator 300. Although not explicitly shown, such signals may be present and utilised in the haptic systems 100 of FIG. 3 and 100-1 of FIG. 4.

A detailed configuration of the haptic control system 200-2 is shown in the lower half of FIG. 6, together with the haptic actuator 300 shown as an LRA load, corresponding to an arrangement in which the haptic actuator 300 is implemented as an LRA. Some or all of the functionality of the haptic control system 200-2 may be provided by a Digital Signal Processor (DSP).

As indicated, an SVC block (or unit or module) receives a pilot tone signal Vref and an output signal from a load sensor, which itself receives the IMON and/or VMON signals mentioned earlier. The pilot tone signal (or bEMF reference signal) Vref may be a PCM (pulse code modulation) or PWLE (piece-wise linear envelope) signal or waveform. Based on Vref and the output signal from the load sensor, the SVC block outputs an input voltage signal Vin (haptic control signal) to the driver. The driver outputs the output voltage signal VOUT (haptic drive signal) based on Vin, to drive the haptic actuator 300. In this way, closed loop control of the haptic actuator 300 (LRA load) is achieved.

In overview, the SVC technique uses the pilot tone signal Vref (or a pilot tone signal modulated to the reference signal Vref) together with the IMON and/or VMON signals (or equivalent data acquired from those signals by integrated analog-digital-converters (ADCs) such as may be provided in the load sensor or SVC block) to measure the actuator back electromotive force (bEMF). Assuming the ambient vibration (e.g. external vehicle/car vibration), or a component thereof, is in the axis of the actuator mass displacement of the haptic actuator 300, the SVC hardware/algorithm can measure the bEMF induced by the ambient vibration on the haptic actuator 300. The SVC block then uses the measured bEMF (vibrational information—the bEMF signal may be proportional to or related to velocity) and a target acceleration or velocity (represented by Vref) to dynamically regulate the input voltage signal Vin (haptic control signal) and thus also the output voltage signal VOUT (haptic drive signal) to compensate for or track the ambient vibration and enable/ensure consistent or desirable haptics performance.

In more detail, the SVC block monitors the load of the haptic actuator 300 and regulates the output voltage drive VOUT via the input voltage signal Vin to cause the monitored bEMF (vibrational information) to follow a target bEMF signal (and therefore compensate for or track the external/ambient vibration). The target bEMF signals (represented by Vref) are designed in velocity domains and may be generated and provided by separate tools (for example, an external software program which generates the target waveforms). The SVC block controls the closed loop, controlling mass velocity (and thus acceleration/excursion by proxy). The SVC block may provide additional functionality including over-excursion protection/prevention, automatic control of overdrive and brake effects, and so on. The SVC block of the closed loop control receives the actual bEMF signal (or generates this signal from received IMON and/or VMON data—as vibrational information) and compares it to the target bEMF signal (represented by Vref) and compensates for any difference between the two signals.

The host processor 250-2 may provide overall control of the haptic control system 200-2, via the I2C interface. Such control may for example comprise triggering haptic effects/specifying desired acceleration, and so on.

FIG. 7 is a schematic diagram of a haptic system 100-3, being another detailed implementation of the haptic systems 100 of FIG. 3 and 100-1 of FIG. 4.

The haptic system 100-3 comprises a haptic control system 200-3 and the haptic actuator 300. The haptic control system 200-3 is a detailed implementation of the haptic control system 200-1 of FIG. 4. Continuing the running example, the haptic system 100-3 may be part or all of the automobile 1 of FIG. 1. Also shown is a host processor 250-3, which may be considered part of the haptic system 100-3 or external to the haptic system 100-3, depending on the application, and corresponding to the host processor 250-2. Duplicate description will therefore be omitted.

A detailed configuration of the haptic control system 200-3 is shown in the lower half of FIG. 7. Some or all of the functionality may be provided by a Digital Signal Processor (DSP).

The haptic system 100-3 employs an SVC technique, similarly to the haptic system 100-2, and this SVC technique is collectively indicated by the SVC block in FIG. 7. For example, the driver and load sensor blocks of FIG. 6 are encompassed by the SVC block of FIG. 7. Accordingly, duplicate description will again be omitted. The SVC block receives the actual bEMF signal of the haptic actuator 300 (or generates this signal from received IMON and/or VMON data), and thus uses the haptic actuator 300 itself as a sensor to measure the ambient vibration (external vehicle/car vibration), and so does not require external sensors to monitor the ambient vibration. The actuator bEMF is proportional to (or is related to, or a function of, or dependent on, e.g. based on a known characterized relationship) the ambient vibration (i.e. the external vehicle/car vibration and the external vehicle/car acceleration condition).

However, the SVC block of FIG. 7 itself operates in an open loop mode in the present arrangement (SVC as in FIG. 6 operates in a closed loop mode but SVC by itself may be unable to compensate for external vibration because of the narrowband nature of the haptic actuator 300, e.g. an LRA). Assuming the ambient vibration has a vibration component on the axis of the actuator, the SVC open loop mode senses that as the actuator bEMF (vibrational information). The SVC hardware/algorithm may monitor the ambient vibration before or during the haptics playback by measuring the bEMF. This bEMF data is then used by an Automatic Vibration Gain Control (AVGC) block to calculate a gain G1 (haptic control signal) that correlates to the current or prior ambient vibration. The AVGC algorithm applied by the AVGC block applies the calculated gain G1 to the target acceleration (represented by Vref) of the haptic actuator 300, for example by multiplication. The applied gain G1 provides the compensation for (or tracking of) the external/ambient vibration to the haptics playback signal VOUT (haptic drive signal).

The relationship between the external/ambient (i.e., vehicle/car) vibration and bEMF of the haptic actuator 300 may be characterized and stored as part of an AVGC tuning file, based on which the gain G1 may be calculated in use. The characterization may use the SVC block in open loop mode to record the bEMF of the vehicle/car under different acceleration conditions and modes.

As before, the host processor 250-3 may provide overall control of the haptic control system 200-3, via the I2C interface. Such control may for example comprise triggering haptic effects/specifying desired acceleration, and so on.

FIG. 8 is a schematic diagram of a haptic system 100-4, being a detailed implementation of the haptic systems 100 of FIG. 3 and 100-1 of FIG. 4.

The haptic system 100-4 comprises a haptic control system 200-4 and the haptic actuator 300. The haptic control system 200-4 is a detailed implementation of the haptic control system 200-1 of FIG. 4. Continuing the running example, the haptic system 100-4 may be part or all of the automobile 1 of FIG. 1.

Again, a host processor 250-4 is also provided, which may be considered part of the haptic system 100-4 or external to the haptic system 100-4, depending on the application. The host processor 250-4 is communicatively coupled to the haptic control system 200-4, in the example arrangement via an I2C serial communication bus and also via an I2S (Inter-Integrated Circuit Sound) serial communication bus. In some arrangements, the host processor 250-4 may be considered part of the haptic control system 200-4, for example corresponding to part or all of the haptic controller 220 of FIG. 4.

Also shown is a force sensor 400-4, which may be considered part of the haptic system 100-4 or external to the haptic system 100-4, depending on the application. The force sensor 400-4 may be considered an external sensor/force sensor or, in the running example, any other onboard sensor of the automobile 1 such as on a haptics/touch subsystem capable to sense (and e.g. digitize) the effects of the ambient vibration (external vehicle/car vibration). That is, other vibration sensors may be used in place of, or in addition to, the force sensor 400-4.

The force sensor 400-4 is communicatively coupled to the haptic control system 200-4, in the example arrangement via a general-purpose input/output (GPIO) connection so that the haptic control system 200-4 can control (e.g. enable/disable) the operation of the force sensor 400-4. As indicated, force data (vibration raw data) from the force sensor 400-4 is provided to the host processor 250-4.

A detailed configuration of the haptic control system 200-4 is shown in the lower half of FIG. 8. Some or all of the functionality may be provided by a Digital Signal Processor (DSP).

The haptic system 100-4 employs an SVC technique, similarly to the haptic system 100-2, and this SVC technique is collectively indicated by the SVC block in FIG. 8. For example, the driver and load sensor blocks of FIG. 6 are encompassed by the SVC block of FIG. 8. Accordingly, duplicate description will be omitted.

Assuming the ambient vibration is in multiple axes compared to the actuator mass displacement, the SVC technique may be used in combination with an Automatic Vibration Cancelation (AVC) block as indicated to track or compensate for the ambient vibration. The AVC algorithm calculates the required haptics pattern needed to cancel the effects of the external (i.e., vehicle/car) vibration (in real-time), and outputs this as a cancelation signal C (haptic control signal). This cancellation signal C is summed with the target acceleration (represented by Vref) of the haptic actuator 300, as indicated.

The host processor 250-4 provides the vibration data (vibrational information) captured by the force sensor 400-4 to the AVC block of the haptic control system 200-4 via the I2S interface, in this example. The haptic control system 200-4 is able to communicate with the force sensor 400-4 via the GPIO link to control what the force sensor 400-4 is providing during haptic playback, if needed. For example, it may be that the force sensor 400-4 is most useful (in terms of contributing to the vibrational information) other than during haptic output (haptic playback) and that the haptic actuator 300 is most useful (in terms of contributing to the vibrational information) during haptic output. It may be that during haptic playback the data from the force sensor 400-4 is less reliable since it may be affected by the haptic playback (haptic output) of the haptic actuator 300, and thus the force sensor 400-4 may be disabled during haptic playback.

The AVC algorithm in this example calculates the root-mean-square (RMS) of the vibration data or creates a phase shift of the vibration data to combine that data C (haptic control signal) with the target acceleration or velocity (represented by Vref) to compensate for the ambient vibration before the SVC block. Taking into account host processor 250-4 latency limitations, the force sensor vibration data may be provided to the AVC algorithm though the I2S interface (e.g. audio interface) and with a minimum delay.

FIG. 9 is a schematic diagram of a haptic system 100-5, being a further detailed implementation of the haptic systems 100 of FIG. 3 and 100-1 of FIG. 4.

The haptic system 100-5 comprises a haptic control system 200-5 and the haptic actuator 300. The haptic control system 200-5 is a detailed implementation of the haptic control system 200-1 of FIG. 4. Continuing the running example, the haptic system 100-5 may be part or all of the automobile 1 of FIG. 1.

Again, a host processor 250-5 is also provided, which may be considered part of the haptic system 100-5 or external to the haptic system 100-5, depending on the application. The host processor 250-5 is communicatively coupled to the haptic control system 200-5, in the example arrangement via an I2C serial communication bus and also via an I2S serial communication bus. In some arrangements, the host processor 250-5 may be considered part of the haptic control system 200-5, for example corresponding to part or all of the haptic controller 220 of FIG. 4.

Also shown is an accelerometer 400-5, which may be considered part of the haptic system 100-5 or external to the haptic system 100-5, depending on the application. The accelerometer 400-5 may be considered an external sensor and may be, in the running example, an accelerometer of the automobile 1. As indicated, acceleration data (acceleration raw data, e.g. vehicle/car acceleration data, as vibrational information) from the accelerometer 400-5 is provided to the host processor 250-5.

A detailed configuration of the haptic control system 200-5 is shown in the lower half of FIG. 9. Some or all of the functionality may be provided by a Digital Signal Processor (DSP).

The haptic system 100-5 employs an SVC technique, similarly to the haptic system 100-2, and this SVC technique is collectively indicated by the SVC block in FIG. 9. For example, the driver and load sensor blocks of FIG. 6 are encompassed by the SVC block of FIG. 9. Accordingly, duplicate description will be omitted.

Assuming the ambient vibration is in multiple axes compared to the actuator mass displacement (and if a sensor corresponding to force sensor 400-4 is not available), SVC is used in combination with an Automatic Acceleration Gain Control (AAGC) algorithm.

The AAGC algorithm processes the acceleration data and calculates the required gain G2 (haptic control signal) to keep consistent performance across external (e.g. vehicle/car) acceleration conditions, which correspond to the ambient vibration. The calculated gain G2 compensates for the effects of the ambient vibration on the haptics playback signal. In the example, the acceleration data (as an input to the AAGC algorithm) may be provided to the AAGC block via the I2C or I2S interface.

The AAGC algorithm applied by the AAGC block applies the calculated gain G2 to the target acceleration (represented by Vref) of the haptic actuator 300, for example by multiplication. The applied gain G2 provides the compensation for (or tracking of) the external/ambient vibration to the haptics playback signal. The relationship between the external/ambient (i.e., vehicle/car) vibration and external acceleration may be characterized and stored as part of an AAGC tuning file, based on which the gain G2 may be calculated in use. The vibration characterization may be accomplished by using an external accelerometer attached to the surface under characterization. Put another way, the AAGC block monitors vibration by using the external (i.e., vehicle/car) acceleration data and a pre-characterized model that contains the relationship between the external (i.e., vehicle/car) acceleration and the external (i.e., vehicle/car) vibration. The AAGC calculates (in real-time) the required gain G2 to apply to the actuator target acceleration (represented by Vref) to compensate for the effects of the ambient vibration on the haptics playback signal VOUT (haptic drive signal).

FIG. 10 is a schematic diagram of a haptic system 100-6, being a detailed implementation of the haptic systems 100 of FIG. 3 and 100-1 of FIG. 4.

The haptic system 100-6 comprises a haptic control system 200-6, a host processor 250-6 and the haptic actuator 300. These correspond to the haptic system 100-5, haptic control system 200-5, host processor 250-5 and haptic actuator 300 of FIG. 9, respectively, and as such duplicate description is omitted.

The difference between haptic system 100-6 and haptic system 100-5 is that the accelerometer 400-5 has been replaced with an operational environment data source 400-6, which in the running example may be considered an automotive environment data source. As indicated, operational environment data (e.g. vehicle/car data) from the source 400-6 is provided to the host processor 250-6.

Situations exist in which a specific vibration sensor or accelerometer may not exist to measure, in the running example, the vehicle/car base vibration level (ambient vibration). Therefore, a combination of available “live” or real-time or any available vehicle/car data may be used (as vibrational data) to model the vehicle/car base vibration level, that is, provide a vehicle/car vibration model based on available vehicle/car data.

In the case of the running example, available vehicle/car data (as vibrational data) may include but is not limited to: 1) Vehicle speed; 2) Audio system output; 3) Window/sunroof status (open, partially open, closed); 4) Rain sensor data; 5) Windshield wiper status; 6) Temperature; 7) Microphone signal level; 8) Powertrain “resonance” data and/or other “rough road” detection algorithm.

For example, with respect to “rough road” detection and for internal combustion engine vehicles, the evaporative emissions system diagnostic may be suspended when a rough road is detected. Rough road may be identified by attempting to correlate it to frothing fuel, which can in turn be concluded as an unreliable diagnostic. Therefore, various pre-existing algorithms, that are not sensor based, use the dynamic differences of multiple antilock braking system (ABS) sensor input to determine if the vehicle is on a rough road surface.

Several of the above vehicle/car data types may be used in combination (e.g., window status in combination with vehicle speed). Even on a battery electric vehicle (BEV), the use of an ABS sensor to detect “rough road” status may be available, even though it will not be needed for evaporative system diagnostics.

Thus, a model may be generated (represented as source 400-6) and used to calculate a reasonably reliable vehicle/car vibration level (ambient vibration level). The model may also use the input of other sensors (further contributing to the vibrational information) which are available in the vehicle to complement the model (e.g., in addition to some or all of the above live vehicle/car data, the accelerometer from the road noise cancellation (RNC)/audio system and/or the accelerometer data from the internal measurement unit (IMU), such as gyros and accelerometers).

As there are many ways and options to derive vehicle/car vibration data (see examples above), i.e. ambient vibration data, it is also likely that on a domain controller vehicle E-architecture (where data is only available to other modules used for similar functions), the easiest accessible data on the vehicle/car might be used-a combination of the above data that relates to the similar function.

In a central compute vehicle E-architecture, all of the above example vehicle/car vibration data may be available in a central computer, and the model may simply use the best combination either for accuracy or data which is easiest to validate for determining the vehicle/car vibration. A vehicle/car is a network system, and such a network system may be utilized for modelling (ambient) vibration. For example, the network system can utilize the detection of rough road determined by an ABS sensor, a rain sensor, microphones, vehicle/car speed, what the audio system is doing, and so on to deduce and model the ambient vibration. The network system may use the model or actuators (e.g. linear resonant actuators (LRAs) such as haptic actuator 300) to determine the vehicle/car vibrations (ambient vibration). The network system may alternately or additionally use a combination of SVC, such as described in relation to FIGS. 6 to 9 above, in conjunction with the vehicle/car data to determine the vehicle/car vibrations. Thus, the arrangements of FIGS. 6 to 10 may be used in any combination.

Looking back at FIGS. 1 and 4, FIGS. 11A to 11F are schematic diagrams useful for better understanding that elements of a haptic system may be distributed across the operational environment. In each case, the automotive environment of the running example is assumed, with the elements thus distributed across the example automobile 1. Although reference is made to the haptic system 100-1 of FIG. 4, similar considerations of course apply to the haptic systems of FIGS. 6 to 10.

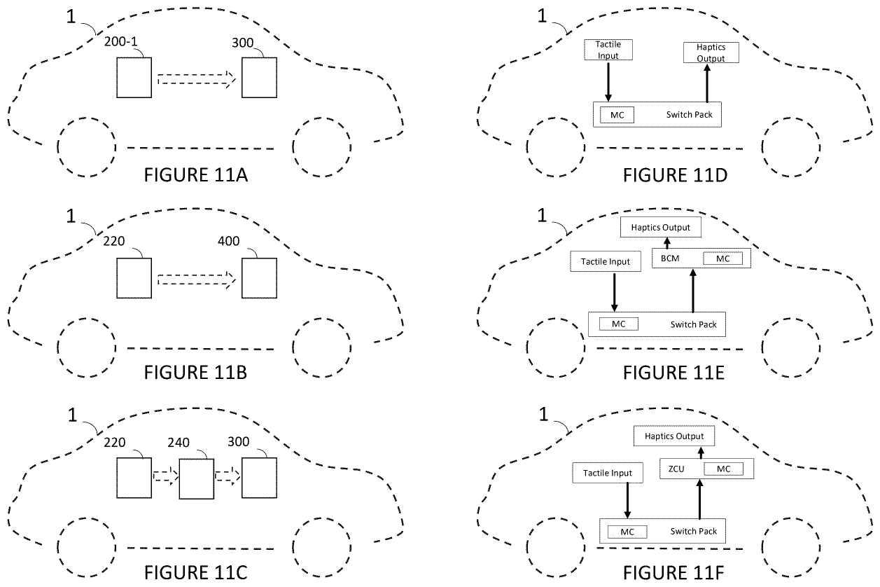

With reference to FIG. 11A, in some arrangements the haptic controller 220 and the haptic driver 240 may be provided together as the haptic control system 200-1 (for example as an integrated circuit) as indicated, separate from the haptic actuator 300. For example, the haptic actuator 300 may be built into an in-car component (e.g. steering wheel, gear stick, driver seat) without co-located driving circuitry, for connection to the remote haptic control system 200-1. With reference to FIG. 11B, in some arrangements the haptic driver 240 and the haptic actuator 300 may be provided together as a haptic module 400 as indicated, separate from the haptic controller 220. For example, the haptic module 400 may be provided as part of an in-car system, such as an in-car entertainment system, for connection to the remote haptic controller 220 (which may be embodied as part of a central compute system of the automobile 1). With reference to FIG. 11C, in some arrangements the haptic controller 220, the haptic driver 240 and the haptic actuator 300 may be provided separately from one another, for example each in its own enclosure, module, component, device, or apparatus.

With reference to FIG. 11D, one sub-module architecture for providing haptics to a vehicle/car is to have a switch pack. An example guideline may be for the switch pack to not make local decisions and to be made a “dumb” peripheral module. An example sub-module architecture is shown having a switch pack that has a microcontroller (MC) responsible for both the sensing of a touch input (as an example user input) and the initiation of the haptic driver/haptic output. The switch pack may receive a tactile/touch input, as indicated, and initiate/provide a haptic output (which may be a function of the tactile/touch input such as a press function). In this case, therefore, the switch pack may correspond to the haptic system 100-1 of FIG. 4, and comprise the haptic controller 220, the haptic driver 240 and the haptic actuator 300. However, such control by the switch pack would go against the above guideline for “no local decisions in a dumb peripheral module”.

In the module employing the haptic experience/feedback, a possible configuration is to have bi-directional digital communication from a switch-pack to a vehicle/car module. One possibility is to employ a domain controller architecture, with the provision of a body control module (BCM) which provides the control for a local haptics module of the vehicle/car. Another possibility is to employ a central compute architecture, with the provision of a Zone Control Unit (ZCU) which provides the control for haptics modules within a wider zone of the vehicle/car.

In the switch pack, there may be a microcontroller, connecting the switch pack to the vehicle/car via digital bus communication. In the switch pack, there will also be the tactile/touch sensor (e.g. capacitive or force sensing with a separate controller or implemented in the switch-pack MC, and the haptic driver & actuator). In most of these peripheral modules, the goal of an original equipment manufacturer (OEM) may be to have them as “dumb” modules where they do not make any decisions. For example, it might not be possible or desirable to update dumb devices during a vehicle over-the-air (OTA) update. A more desirable sub-module architecture, with the above in mind, may be that the switch-pack MC receives the tactile/touch input and communicates this information via the digital communication bus to the vehicle controller (direct (local) or indirect (relayed) command).

FIG. 11E shows an example direct (local) sub-module architecture, that is, a localized haptics module for the vehicle/car. The switch pack receives the tactile/touch input, as before. The tactile/touch information is sent to the BCM. The microcontroller (MC) of the BCM (and not the MC of the switch pack) makes the decision on how to provide the haptics output. In other words, the MC of the BCM acts on the switch press (e.g. turns on/off a function e.g. a light) and simultaneously also commands the appropriate haptics initiation. In this case, therefore, the BCM may correspond to the haptic controller 220 of FIG. 4, with the haptic driver 240 and the haptic actuator 300 provided as part of the switch pack or with the haptic driver 240 and the haptic actuator 300 provided separately from the switch pack.

FIG. 11F shows an example indirect (relayed command) sub-module architecture, that is, a relayed command haptics module for the vehicle/car. The switch pack receives the tactile/touch input, as before. The tactile/touch information is sent to the ZCU. The microcontroller (MC) of the ZCU (and not the MC of the switch pack) makes the decision on how to provide the haptics output. In other words, the MC of the ZCU acts on the switch press (e.g. turns on/off a function such as a light) and simultaneously also commands the appropriate haptics initiation. As long as the bus communication is fast enough, and the processing of the data is fast enough, the delay for the relaying of the function switch press to haptics initiation will be imperceptible to the user. In this case, similarly, the ZCU may correspond to the haptic controller 220 of FIG. 4, with the haptic driver 240 and the haptic actuator 300 provided as part of the switch pack or with the haptic driver 240 and the haptic actuator 300 provided separately from the switch pack.

These direct (local) and indirect (relayed command) architectures have the benefit that in case the vehicle manufacturer wants to update or change the haptics tuning of the vehicle, it can do so by respectively updating the BCM and ZCU. In an implementation that uses either a model, sensor, or a combination of the data to calculate a vehicle/car vibration level which will in turn be used to change the way the haptic actuator is driven, the benefit of the dumb submodule with local/relayed command of haptic by the BCM/ZCU is that in case, there is a change in the feature desired (update) by the OEM, this change is possible by updating the software (SW) in the BCM/ZCU and the switch pack remains unchanged. An example might be that customer feedback reveals that the haptic feedback is too strong during a specific driving condition (e.g., at high speed on a rough road). If the haptic driver has a mapped output of 10 levels and level 10 was supplied (i.e. by providing a haptic control signal of value 10) in this specific condition before, a new SW version may be updated (OTA) instead selecting that in this specific situation, the haptic drive is reduced to 8 (i.e. by providing a haptic control signal of value 8), but with a slightly longer duration. i.e. the haptic response of the switch pack is updated vs. the previous function, but the software in the switch pack itself is not changed—only the software in the BCM/ZCU.

It will be appreciated that the haptic systems disclosed herein may be implemented in either the direct (local) and indirect (relayed command) sub-module architecture.

As above, the running example focusses on automotive environments as a convenient example environment in which there may be considerable ambient vibration. However, it will be appreciated that the techniques disclosed herein may equally be applied in other environments in which there may be considerable ambient vibration.

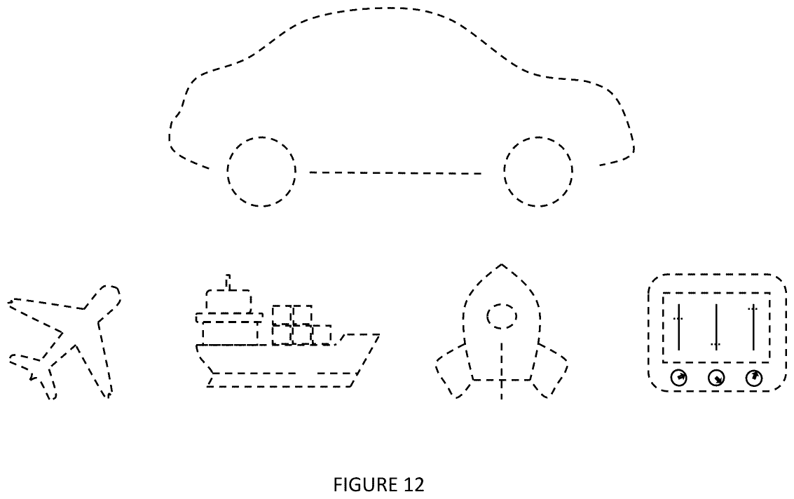

With reference to FIG. 12, the haptic systems and haptic control systems may thus be or be part of an automobile, an aircraft, a watercraft, a spacecraft, or an industrial plant or industrial equipment, and the skilled person will appreciate that these are examples. An automobile may be considered a vehicle (e.g. a car, van, truck, bus, coach, bicycle or motorbike), such as a road or off-road vehicle. An aircraft may be considered a machine (e.g. an aeroplane, glider, or helicopter) that can travel through the air and that is supported either by its own buoyancy or by the action of the air against its surfaces. A watercraft or waterborne vessel may be considered any vehicle designed for travel across or through water, including a boat, ship, hovercraft, submersible or submarine. A spacecraft may be considered a vehicle or device designed for travel or operation outside the earth's atmosphere, and/or for travel to or from such an environment. An industrial plant may be considered a combination of machines, apparatus, appliances, equipment, instruments and materials which together make up a large-scale unit producing goods or providing services.

There may thus be provided an automobile, an aircraft, a watercraft, a spacecraft, an industrial plant or industrial equipment (or an electrical or electronic device or apparatus thereof) comprising any of the haptic control systems or any of the haptic systems disclosed herein. Generally, there may be provided an operational environment of a haptic actuator susceptible to ambient vibration, comprising any of the haptic control systems or any of the haptic systems disclosed herein. Where the operational environment is that of an aircraft, a watercraft, a spacecraft, an industrial plant or industrial equipment or an electrical or electronic device, references in the running example to the automotive environment, automobiles, cars or vehicles (or systems, elements, components, or vibration sources thereof) may be replaced with equivalent references to crafts, plants or equipment or devices/apparatus (or systems, elements, components, or vibration sources thereof), as appropriate. For example, aerospace, industrial and naval/nautical operational environments are envisaged.

The present disclosure has focused on control of one or more haptic actuators, and in particular control of the level of haptic output in the sense of strength or ‘volume’ of the output. The inventors have, however, recognised that by focusing on user perception of haptic outputs (haptic feedback, or a haptic experience) there is an opportunity to, for example, reduce or limit haptic actuator size/power and thus related costs while maintaining or improving the user experience. For example, a haptic output, or haptic experience, may be perceived by a user as stronger or more pronounced if increased in duration and/or accompanied by another transducer output such as an audio or visual output.

The inventors have therefore considered the range of transducers potentially available in the operational environment (e.g. automotive environment, continuing the running example), as well as factors which are controllable in addition to, or instead of, the level of haptic output itself.

Available transducers include, along with haptic transducers (haptic actuators), audio/visual transducers. An audio/visual transducer will be understood here to be an audio and/or visual transducer, and thus operable to generate an audio and/or visual output. An example audio/visual transducer may be a speaker operable to generate an audio output (but not a visual output). Another example audio/visual transducer may be a light or screen operable to generate a visual output (but not an audio output). A haptic transducer may in some arrangements be employed as an audio/visual transducer, in particular as an audio transducer operable to generate an audio output (but not a visual output).

Controllable factors include the presence or absence of an output, which ‘track’ or waveform (e.g. audio/visual/haptic waveform or pulse or ‘click’) is used for the output, a duration of an output, a frequency of an output, a timing of an output (including relative to another output), and a level of an output. Where multiple transducers are employed, such factors may be considered on a per transducer or per transducer combination basis.

With haptic actuator (haptic transducer) size/power in mind, in the case of ambient vibration compensation which only increases haptic amplitude to increase the perceived haptic strength to compensate for increased ambient vibration, the maximum amplitude is limited by the actuator design. Thus, in this case, the total energy or “perceived haptic strength” (for a fixed duration haptic waveform) is directly linked to the actuator design (power/size). This may lead to increased haptic actuator costs where increased perceived haptic strength is needed.

However, taking duration as an example factor, a form of ambient vibration compensation may be to increase the haptic output (pulse/track/waveform) duration (and optionally also the haptic amplitude). The total amount of energy applied in a haptic pulse may be increased by either amplitude, or duration or both. Put another way, by increasing haptic pulse duration in addition to or instead of haptic pulse amplitude, it may be possible to provide a given “perceived haptic strength” with a lower size/power, and thus cost, haptic actuator.

Taking an example haptic output in the form of a pulse intended to be perceived as a haptic ‘click’, increased duration, or a lower haptic output frequency may give a less “sharp” click perception, but the perceived strength may be significantly higher. Thus, duration and/or frequency factors may be controlled. A short high-definition click waveform may be used in a low noise (ambient or background vibration) environment to get a good click feel, with a nominal amplitude (e.g. maximum design amplitude of the relevant haptic actuator/transducer) and short duration. This may be transitioned though ambient vibration compensation to a longer duration pulse at the same amplitude at higher background vibration levels, with the perceived strength of the click being increased, albeit with a reduction of the “sharpness” feeling of the haptic effect. In this way, the need for a haptic actuator that is designed to provide a higher acceleration (e.g. of an associated smart surface), which would typically be a larger, higher-mass, higher-cost actuator, may be averted. A higher strength, lower definition haptic click can be used in this way if the user accepts a lower-definition feeling for higher background vibration levels to get a higher perceived haptic strength as part of ambient vibration compensation. A higher-definition click feeling may still be retained at low background vibration levels when the user is most likely to be focused on the “finesse” of their haptic feedback.

Considering a potential audio/visual output accompanying a haptic output, a change in audio frequency e.g. lower frequency audio click tone when in a higher vibration environment) may also provide a stronger haptic click perception, albeit with a potential loss of perceived sharpness/finesse/quality of the click. A change in waveform (e.g. a higher or lower frequency audible tone) in conjunction with a longer duration haptic event, or tuning a combination of haptic strength/duration and audio tones, offers tuning possibilities to enhance the perceived quality of a haptic (or HMI) effect at the same time as optimizing or controlling the perceived strength when compensated with respect to the background vibration in the environment. Other variables/factors may be controlled to provide a higher perceived haptic strength or better perceived feeling at higher background vibration levels of a desired HMI event, as mentioned above. For example, a potential audio/visual output accompanying a haptic output may be transitioned from absent to present with increasing ambient vibration. HMI feedback requirements may thus involve haptic, audio or visual feedback or a combination of haptic and audio/visual feedback.

A reduction in the actuator size/power (or number of actuators) may lead to material cost reduction in the bill of materials (BOM) of a larger system, such as a component part or all of an automobile. A reduction in the actuator size/power (or number of actuators) may lead to improved packaging options for a system integrator and lead to a commercial advantage.

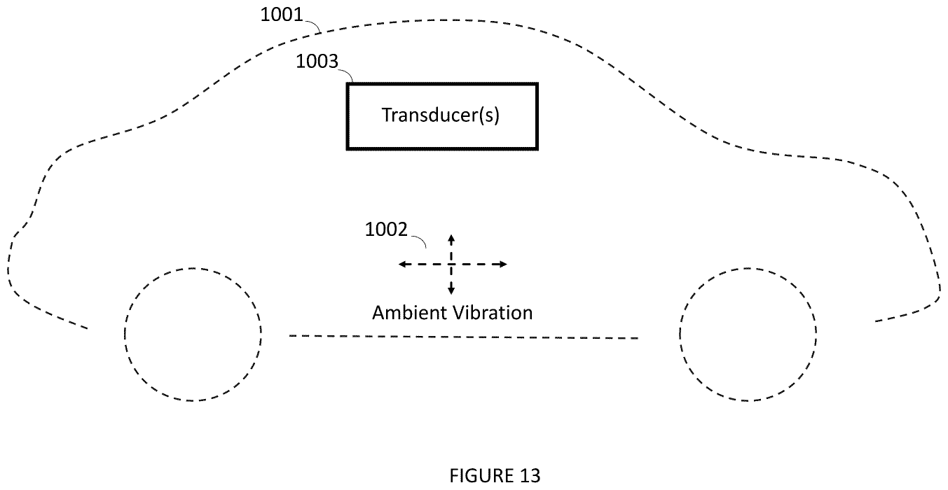

Against this backdrop, reference is made to FIGS. 13 to 16 which correspond to FIGS. 1 to 4, respectively, except that the haptic actuator has been replaced with one or more transducers, and the various modules, systems, steps as appropriate are for transducer control in general (including haptic transducer control) rather than focusing on haptic actuator control. Similar reference signs have been used between the corresponding figures to help show correspondence therebetween, with the reference numbers being 1000 higher in value in FIGS. 13 to 16 (so that 1 becomes 1001, 10 becomes 1010, and so on). As such, duplicate description will be omitted where possible and FIGS. 13 to 16 will be understood based on an understanding of FIGS. 1 to 4, respectively.

FIG. 13 is a schematic diagram of an example automotive environment 1001, for use in better understanding arrangements of the present disclosure.

The one or more transducers 1003 in FIG. 13 correspond to the haptic actuator 3 in FIG. 1 and indeed comprise the haptic actuator (haptic transducer) 3. The one or more transducers 1003 may comprise other transducers including audio transducers or visual transducers. At least one transducer 1003 may thus be controlled to provide haptic feedback, as before. It is desirable to control the one or more transducers 1003 based on the level of ambient vibration in the operational environment of the one or more transducers 1003.

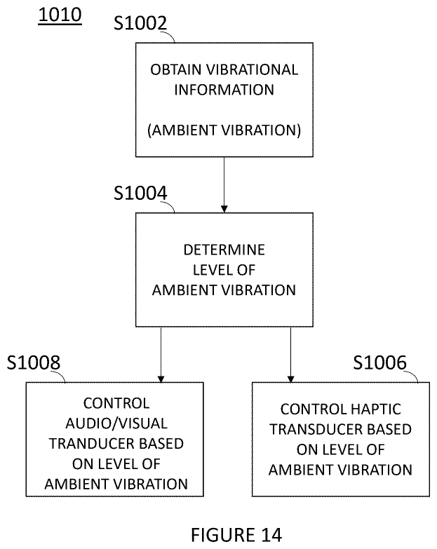

FIG. 14 is a schematic diagram of a control method 1010 for use in controlling the one or more transducers 1003, comprising steps S1002, S1004 and S1006. The control method 1010 may be referred to as an automotive control method in the running example.

Steps S1002, S1004 and S1006 correspond to steps S2, S4 and S6 of FIG. 2, respectively. Step S1006 may comprise generating a haptic control signal for use in controlling the haptic output of a haptic transducer of the one or more transducers 1003.

Step S1008 comprises generating, for a haptic event having the haptic output, an audio/visual control signal for at least one audio/visual transducer of the one or more transducers 1003 so that at least a corresponding audio or visual output accompanying the haptic output is a function of a level of ambient vibration in an operational environment of the one or more transducers 1003. The haptic control signal may be generated so that the haptic output (e.g. its duration or frequency) is a function of the level of ambient vibration.

Steps S1002, S1004 and S1006 may be considered optional so that method 1010 may comprise step S1008 alone (or, for example, steps S1002, S1004 and S1008). For example, it may be that an audio or visual output accompanying the haptic output is a function of a level of ambient vibration, but that the haptic output itself is not controlled (or not always controlled) as a function of the level of ambient vibration.

Steps S1002, S1004 and S1008 may be considered optional so that method 1010 may comprise step S1006 alone (or, for example, steps S1002, S1004 and S1006). For example, it may be that the haptic output (e.g. its duration or frequency) is a function of the level of ambient vibration, but that an audio or visual output accompanying the haptic output is not controlled (or not always controlled) as a function of the level of ambient vibration.

In some arrangements, it may be that an audio or visual output is not, or not necessarily, provided. As an example, a haptic control signal may be generated so that a duration of the haptic output (and optionally not the level of the haptic output) is a function of the level of ambient vibration. As another example, a haptic control signal may be generated so that a frequency of the haptic output but not the level of the haptic output is a function of the level of ambient vibration.

As an example, it will be assumed that an audio/visual output is available along with the haptic output in the following.

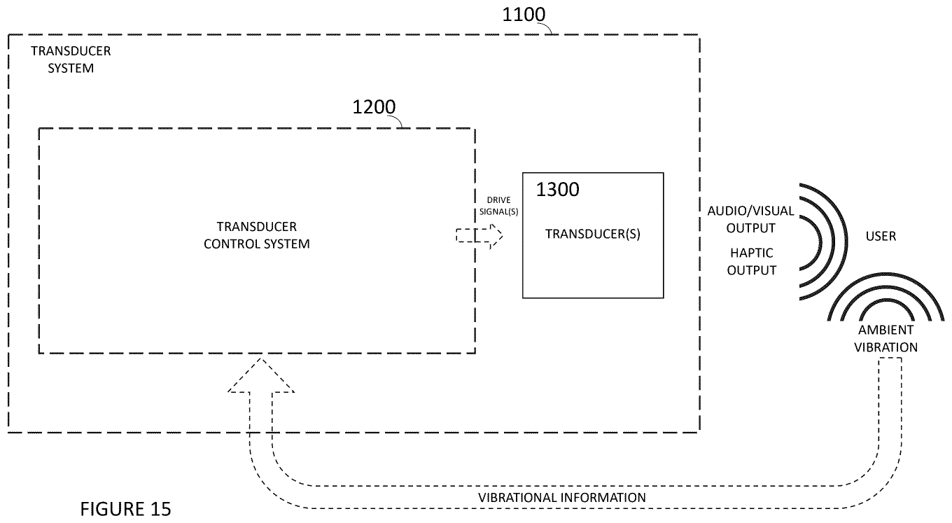

FIG. 15 is a schematic diagram of a transducer system 1100 (e.g. part or all of the automobile 1000) which comprises a transducer control system 1200 and one or more transducers 1300, and which is configured to carry out the control method 1010.

As indicated, in use the one or more transducers 1300 are configured to provide a haptic output to provide the user with a haptic experience and also an audio/visual output. As before, the user is also subject to ambient vibration.

The transducer control system 1200 is configured to control the one or more transducers 1300 with corresponding drive signals as indicated, based on the vibrational information. By virtue of this control, the drive signal of at least one audio/visual transducer of the one or more transducers 1300 may be a function of a level of ambient vibration in an operational environment of the one or more transducers 1300. The drive signal of at least one haptic transducer of the one or more transducers 1300 may also be a function of the level of ambient vibration.

As before, the vibrational information may be based on measurement (e.g. with a haptic transducer) or estimation of the ambient vibration. A vibration estimation model may for example be employed, and incorporate data of other vibration sources in the environment such as (in the context of an automobile as in the running example) a HVAC blower fan speed, an infotainment system audio output level, status of the windows, doors, sunroof, operation of the wipers or windshield rain sensor etc., vehicle speed and rough road detection of the suspension and/or drivetrain system. The base/background vibration characteristics in the application may thus be measured, modelled (or estimated using additional system parameters), and then compensated for.

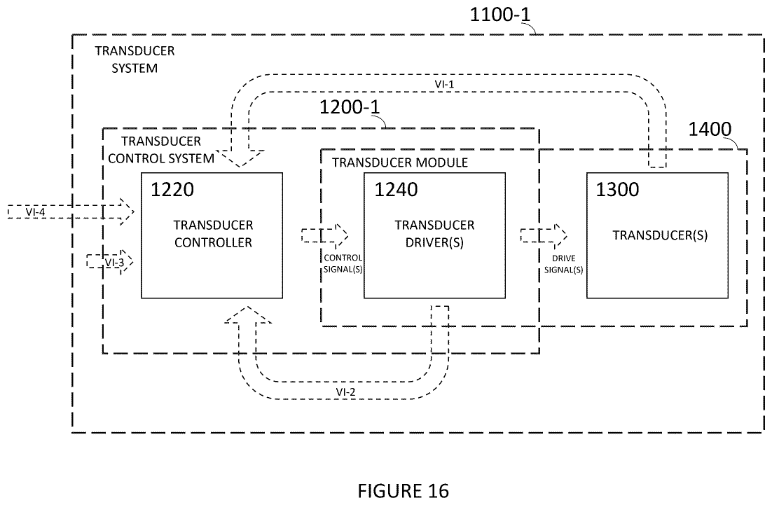

FIG. 16 is a schematic diagram of a transducer system 1100-1, being a detailed implementation of the transducer system 1100 of FIG. 15. The transducer system 1100-1 comprises a transducer control system 1200-1 and the one or more transducers 1300. The transducer control system 1200-1 comprises a transducer controller 1220 and one or more transducer drivers 1240. The transducer controller 1220 is configured to generate (and output) one or more transducer control signals and the one or more transducer drivers 1240 are configured to generate (and output) one or more transducer drive signals based on the one or more transducer control signals. The transducer control system 1200-1 is a detailed implementation of the transducer control system 1200 of FIG. 15. The combination of the one or more transducer drivers 1240 and the one or more transducers 1300 may be referred to as a transducer module 1400, or one or more respective transducer modules 1400 (i.e. driver plus transducer), corresponding to the haptic module 400 of FIG. 4.

At least one of the one or more transducers 1300 is a haptic transducer operable to generate a haptic output and (where an audio/visual output is available) at least one of the one or more transducers is an audio/visual transducer operable to generate an audio or visual output. A transducer control signal for controlling a haptic transducer (haptic actuator) may be referred to as a haptic control signal, as earlier. A transducer control signal for controlling an audio/visual transducer may be referred to as an audio/visual control signal.

It may be that at least one of the one or more transducers is or comprises both a haptic transducer and an audio/visual transducer. For example, a haptic actuator may be employed to generate a haptic output and/or an audio output, potentially simultaneously (with an appropriate drive signal) where both are generated. In some arrangements, the at least one audio/visual transducer may comprise a speaker, operable to generate an audio output but not a visual output. In some arrangements, the at least one audio/visual transducer may comprise a light or screen, operable to generate a visual output but not an audio output.

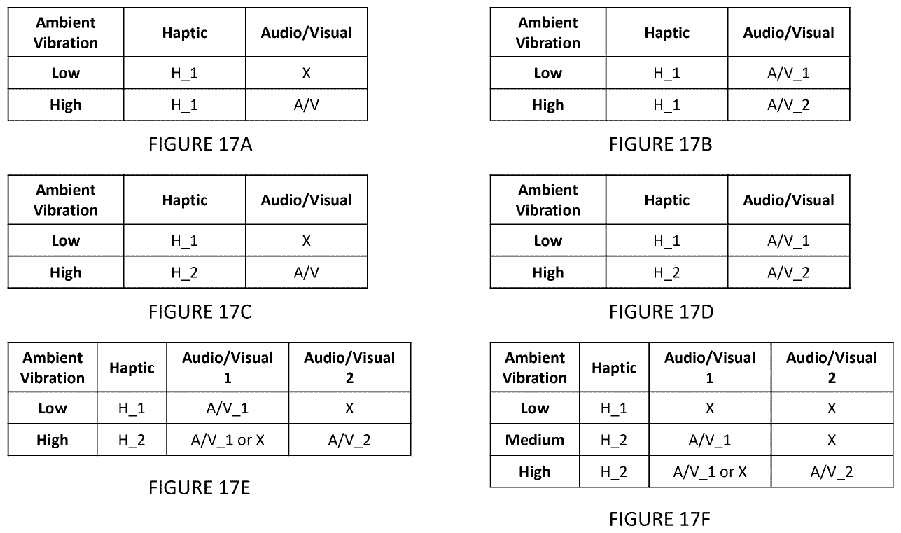

Accordingly, it will be understood that in some arrangements at least audio/visual transducer control as a function of the level of ambient vibration may be provided and that both haptic transducer and audio/visual transducer control may be provided as a function of the level of ambient vibration, depending on the application. This may be better understood with reference to FIGS. 17A to 17F, which are tables (which may be implemented as look-up tables) useful for understanding potential ways in which haptic and/or audio/visual outputs may be controlled. In each case, relative levels of ambient vibration are indicated as low, medium or high, and corresponding settings for haptic and audio/visual outputs are provided.

In the example of FIG. 17A, the haptic output (or haptic transducer) is controlled such that it is not a function of the level of ambient vibration, i.e. its output is the same (H_1) for each ambient vibration level. However, the audio/visual output (or audio/visual transducer) is controlled as a function of the level of ambient vibration. Here, the audio/visual output is absent (X) when the ambient vibration is low and present (A/V) when the ambient vibration is high. In this way, the user may perceive a stronger haptic output when the ambient vibration is high compared to when it is low by virtue of the accompanying audio/visual out becoming present rather than absent, without the need to increase the strength of the haptic output itself.

In the example of FIG. 17B, the haptic output is again controlled such that it is not a function of the level of ambient vibration, i.e. its output is the same (H_1) for each ambient vibration level, and again the audio/visual output is controlled as a function of the level of ambient vibration. Here, the audio/visual output has one setting (A/V_1) when the ambient vibration is low and another setting (A/V_2) when the ambient vibration is high. In this way, the user may perceive a stronger haptic output when the ambient vibration is high compared to when it is low by virtue of the accompanying audio/visual out changing from A/V_1 to A/V_2, without the need to increase the strength of the haptic output itself.

As above, the change from A/V_1 to A/V_2 may include a change in any or all of which ‘track’ or waveform is used for the output, a duration of the output, a frequency of the output, a timing of the output (including relative to the haptic output), and a level of the output.

In the example of FIG. 17C, the haptic output is controlled such that it is a function of the level of ambient vibration. Here, the haptic output has one setting (H_1) when the ambient vibration is low and another setting (H_2) when the ambient vibration is high. Like in FIG. 17A, the audio/visual output is absent (X) when the ambient vibration is low and present (A/V) when the ambient vibration is high. In this way, the user may perceive a stronger haptic output when the ambient vibration is high compared to when it is low by virtue of the accompanying audio/visual output becoming present rather than absent, and also due to the haptic output changing from H_1 to H_2.

As above, the change from H_1 to H_2 may include a change in any or all of which ‘track’ or waveform is used for the output, a duration of the output, a frequency of the output, a timing of the output (including relative to the audio/visual output), and a level of the output.

In the example of FIG. 17D, the haptic output has one setting (H_1) when the ambient vibration is low and another setting (H_2) when the ambient vibration is high, as in FIG. 17C. Like in FIG. 17B, the audio/visual output has one setting (A/V_1) when the ambient vibration is low and another setting (A/V_2) when the ambient vibration is high. In this way, the user may perceive a stronger haptic output when the ambient vibration is high compared to when it is low by virtue of the accompanying audio/visual output changing from A/V_1 to A/V_2 and also due to the haptic output changing from H_1 to H_2.

The change from A/V_1 to A/V_2 may also involve a change in which, or how many, audio/visual transducers are employed, as this may be better understood by considering FIGS. 17E and 17D.

In the example of FIG. 17E, there are two audio/visual outputs (transducers) indicated, audio/visual 1 and audio/visual 2. The haptic output is controlled such that it is a function of the level of ambient vibration. The haptic output has one setting (H_1) when the ambient vibration is low and another setting (H_2) when the ambient vibration is high, as before. The audio/visual output 1 is present (A/V_1) when the ambient vibration is low and either present (A/V_1) or absent (X) when the ambient vibration is high. The audio/visual output 2 is absent (X) when the ambient vibration is low and present (A/V_2) when the ambient vibration is high. In this way, the user may perceive a stronger haptic output when the ambient vibration is high compared to when it is low by virtue of the accompanying audio/visual output 2 becoming present rather than absent, to add to or replace the accompanying audio/visual output 1, and also due to the haptic out changing from H_1 to H_2. In a variant, H_2 may be replaced by H_1.

In the example of FIG. 17F, there are again two audio/visual outputs (transducers) indicated, audio/visual 1 and audio/visual 2. There are also three levels of ambient vibration, namely low, medium and high. The haptic output has one setting (H_1) when the ambient vibration is low and another setting (H_2) when the ambient vibration is medium and high. The audio/visual output 1 is absent (X) when the ambient vibration is low, present when the ambient vibration is medium (A/V_1) and either present (A/V_1) or absent (X) when the ambient vibration is high. The audio/visual output 2 is absent (X) when the ambient vibration is low or medium and present (A/V_2) when the ambient vibration is high. In this way, the user may perceive a stronger haptic output when the ambient vibration is medium compared to when it is low by virtue of the accompanying audio/visual output 1 becoming present rather than absent, and also due to the haptic out changing from H_1 to H_2. The user may perceive an even stronger haptic output when the ambient vibration is high compared to when it is medium by virtue of the accompanying audio/visual output 2 becoming present rather than absent, to add to or replace the accompanying audio/visual output 1. This even stronger haptic output perceived when the ambient vibration is high compared to when it is medium may be so even though the haptic output itself has remained the same (H_2), i.e. with the change in perception being due to the change in one or both of the audio/visual outputs.

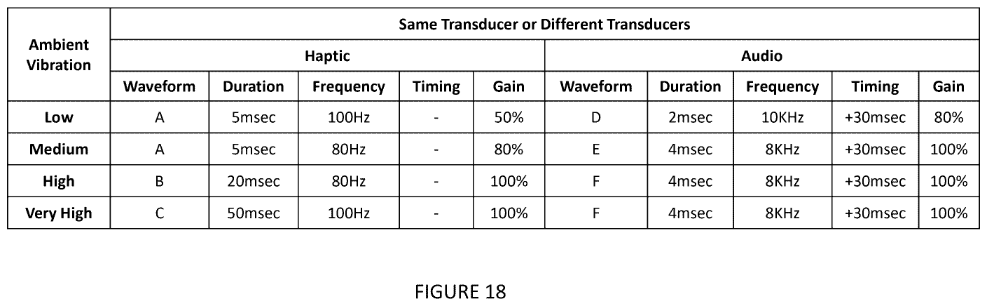

To further exemplify that a range of factors may be controlled, reference is made to FIG. 18, which is a table similar to those of FIGS. 17A to 17F. The audio/visual control signal concerned may be generated so that at least one of: a presence or absence of the audio or visual output; which audio or visual track is used for the audio or visual output; a duration of the audio or visual output; a frequency of the audio or visual output; a timing of the audio or visual output relative to a timing of the haptic output; and a level of the audio or visual output, is a function of the level of ambient vibration. The haptic control signal may also be generated to provide similar control of the haptic output.

In the example of FIG. 18, there is a haptic output and an audio output (as an example audio/visual output). There are also four levels of ambient vibration, namely low, medium, high and very high. The haptic and audio outputs are controlled such that they are a function of the level of ambient vibration. The waveforms (e.g. tracks, pulses, clicks) of the haptic output are set dependent on the level of ambient vibration, indicated as A, A, B and C, respectively. The same is true for the audio output, indicated as D, E, F and F, respectively. Similarly, the respective waveform gains (strength), durations and frequencies are set dependent on the level of ambient vibration, as indicated.

It will be appreciated that by controlling such factors it may be possible to control the user perception of a haptic experience, without the control (only) being of the haptic output itself or (only) of the strength/level of the haptic output itself, or in some cases without needing to control the haptic output at all. Such control may enable the design of a haptic actuator to be kept within tighter design limits than if only control of the haptic output itself were considered.

Although separate haptic and audio outputs are shown, it will be understood that both outputs could be from the same haptic transducer of the one or more transducers 1003, 1300. Also, although only one audio output is shown, there could be plural audio outputs in line with FIGS. 17D and 17E, with each output being controlled independently or with multiple outputs being controlled in combination.

In the case of an automobile, for example, one audio output may be generated by the haptic actuator and the other audio output may be from the automobile infotainment system. Example audio outputs in the context of an automobile include outputs from a haptic actuator, from a speaker of an infotainment system, from a connected wireless headset or set of earbuds, or even from the horn. Similarly, there could be plural haptic outputs, from different haptic actuators. Of course, instead of, or in addition to, audio outputs there could be visual outputs. Example visual outputs in the context of an automobile include outputs from trim lighting, such as beading or ambient trim, a head-up display, a display screen, courtesy lighting, instrument or dashboard lighting, puddle, map or dome lighting, or HMI lighting such as lighting on a gear stick. Exterior lighting could also be controlled.

FIG. 18 will therefore be understood accordingly as indicative of how plural haptic/audio/visual outputs could be controlled in general. Controlling the transducers may comprise controlling how many, or which, transducers are driven/controlled.

Although FIGS. 17D and 17E and FIG. 18 present discrete values or settings for given ambient vibration values or ranges, it will of course be understood that parameter values may be interpolated, blocked, linearized or calculated in one or more multi-dimensional map(s), either on a fixed or adaptive basis.

As above, at least one audio/visual control signal may be controlled so that it at least partly tracks (or compensates for or responds to) a change in the vibrational information indicative of a change in the level of ambient vibration. This control may be performed during the audio/visual output (and potentially during the accompanying haptic output). In some arrangements, the control of the value of the audio/visual control signal may comprise adjusting the value of the audio/visual control signal to tend to keep a difference or ratio between the value of the audio/visual control signal and the level of ambient vibration above a threshold level, within a target range and/or substantially constant.

The controller 1220 may be configured to determine when it is worthwhile controlling the at least one audio/visual control signal based on the ambient vibration. For example, in some cases the ambient vibration may be relatively weak or negligible from the point of view of its effect on the user. As another example, an audio/visual output may be deemed only necessary when the level of ambient vibration is high or very high. The controller 1220 may thus be configured to control the at least one audio/visual control signal and/or haptic control signal differently in different circumstances. This may take into account one or more operational factors, such as one or more user-related, usage-related or environmental factors.

For example, how the controller 1220 controls the one or more control signals may be dependent on at least one of: a history of haptic outputs; a history of detected user responses to haptic outputs; a user setting or system setting; a categorisation of the haptic output, optionally wherein the haptic output is configured to have a high-priority categorisation, a low-priority categorisation, a safety-related categorisation, an emergency categorisation, an alert categorisation (e.g. a haptic alert, such as a lane control alert) and/or an informational categorisation; and information defining the operational environment of the haptic actuator (e.g. a characteristic of the user (e.g. their weight or age or a hearing (dis) ability status), time of day, location, ambient temperature, ambient audible noise level, estimated user distraction level, type of automobile, speed, and/or acceleration).

It is therefore envisaged that ambient vibration may be compensated for by way of an audible waveform, where the audible tone is played by a smart haptic driver using the haptics actuator and smart surface (i.e. a surface to which the haptics actuator is affixed) driven in the audible frequency range. Such an audio waveform may be controlled independently and separately from any haptic waveform being driven using a haptic driver, haptic actuator, smart surface system. Such an audio waveform may be used to compensate for ambient vibration where the audible waveform and a haptics waveform are played essentially concurrently for the purposes of human perception with intent to be perceived as a single HMI feedback event. A haptic event and audio event may be driven into the same haptic actuator at their respective frequencies and separated by an imperceptible (to a human user) time delay. For example, the haptic and audio events may be less than 30 msec apart (see, e.g. FIG. 18), constituting as a single HMI event received by the human touch and auditory systems. Such an audio waveform may be used to compensate for ambient vibration where both the audio event and the haptics event are considered part of the same HMI feedback event. And both the audio waveform characteristics and the haptics waveform characteristics may be controlled (adjusted) dependently or independently of each other to compensate for ambient vibration.

The ambient vibration compensation may be implemented using a set of 2D lookup tables (see, for example, FIGS. 17A to 17F and 18) or 3D or multi-dimensional maps for each of the compensated elements such as strength, frequency, duration, amplitude (gain).

By way of example, the frequency range for the audible effects may be considered in the 100-20,000 Hz range and for audible clicks typically in the 1-12 KHz range. The frequency range for the haptics effects may be considered in the receptor frequency range 5-1000 Hz and most typically for haptic click feedback in the 10-300 Hz range. Such haptic and audio effects may be generated by the same haptic transducer (haptic actuator) driven accordingly. In this way, the audio and haptic tones (controlled as above to compensate for ambient vibration) may be driven synchronously into the same smart surface.

In line with earlier examples, the driver system (internally or by means of relaying the data to a remote processor and receiving compensation parameters or compensated waveforms) calculates the compensated waveforms to be driven based on the system vibration condition. The haptic frequency tone is received primarily by the touch receptors in the fingertips (lower frequency). If an audio output is present, the audio frequency tone is received primarily by the audio receptors in the ear (higher frequency). The brain receives the audio and haptic feedback elements of the HMI event and perceives them as the same, multi-sensory event.

The skilled person will recognise that some aspects of the above-described apparatus (circuitry), devices and methods may be embodied as processor control code, for example on a non-volatile carrier medium such as a disk, CD- or DVD-ROM, programmed memory such as read only memory (Firmware), or on a data carrier such as an optical or electrical signal carrier. For example, any of the haptic systems, haptic control systems, haptic controllers or haptic drivers (or parts thereof) may be implemented as a processor operating based on processor control code. For some applications, such aspects will be implemented on a DSP (Digital Signal Processor), ASIC (Application Specific Integrated Circuit) or FPGA (Field Programmable Gate Array), as mentioned earlier. Similar considerations apply for any of the transducer systems, transducer control systems, transducer controllers or transducer drivers (or parts thereof).

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in the claim, “a” or “an” does not exclude a plurality, and a single feature or other unit may fulfil the functions of several units recited in the claims. Any reference numerals or labels in the claims shall not be construed so as to limit their scope.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be understood—especially by those having ordinary skill in the art with the benefit of this disclosure—that the various operations described herein, particularly in connection with the figures, may be implemented by other circuitry or other hardware components. The order in which each operation of a given method is performed may be changed, and various elements of the systems illustrated herein may be added, reordered, combined, omitted, modified, etc. It is intended that this disclosure embrace all such modifications and changes and, accordingly, the above description should be regarded in an illustrative rather than a restrictive sense.

Similarly, although this disclosure makes reference to specific embodiments, certain modifications and changes can be made to those embodiments without departing from the scope and coverage of this disclosure. Moreover, any benefits, advantages, or solutions to problems that are described herein with regard to specific embodiments are not intended to be construed as a critical, required, or essential feature or element. Further embodiments likewise, with the benefit of this disclosure, will be apparent to those having ordinary skill in the art, and such embodiments should be deemed as being encompassed herein.

To aid the Patent Office (USPTO) and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

The present disclosure extends to the following statements:

### Group S:

S1. A haptic control system for controlling a haptic output of a haptic actuator, the haptic control system comprising:
   a haptic controller configured to:
      obtain vibrational information indicative of a level of ambient vibration in an operational environment of the haptic actuator;
      determine the level of ambient vibration from the vibrational information; and
      generate a haptic control signal for use in controlling the haptic output of the haptic actuator, wherein a value of the haptic control signal is a function of the level of ambient vibration.
S2. The haptic control system of statement S1, wherein:
   the vibrational information comprises, or is based on, a measurement of the level of ambient vibration; and/or
   the value of the haptic control signal comprises or is a level or DC component of the haptic control signal; and/or
   the haptic output is a discrete haptic output having a duration, and the haptic controller is configured to generate the haptic control signal such that its value is substantially constant for the duration of the discrete haptic output or is adjusted relatively slowly over the duration of the discrete haptic output; and/or
   the haptic output comprises a series of discrete haptic outputs each having a duration, and the haptic controller is configured to generate the haptic control signal such that its value is substantially constant for the duration of each the discrete haptic output but different for different discrete haptic outputs, optionally when the level of ambient vibration is different for different discrete haptic outputs.
S3. The haptic control system of statement S1 or S2, wherein the haptic controller is configured to control the value of the haptic control signal to at least partly compensate for or track a change in the vibrational information indicative of a change in the level of ambient vibration.
S4. The haptic control system of any of the preceding statements, wherein:
   the vibrational information comprises prior vibrational information, indicative of the level of ambient vibration prior to said haptic output, the prior vibrational information optionally obtained prior to said haptic output; and/or
   the vibrational information comprises current vibrational information, indicative of the level of ambient vibration during said haptic output, the current vibrational information optionally obtained during said haptic output.
S5. The haptic control system of any of the preceding statements, wherein the haptic controller is configured to adjust the value of the haptic control signal based on the level of ambient vibration, optionally during said haptic output.
S6. The haptic control system of any of the preceding statements, wherein the haptic controller is configured to adjust or set the function of the level of ambient vibration based one or more operational factors, such as one or more user-related, usage-related or environmental factors.
S7. The haptic control system of any of the preceding statements, wherein the haptic controller is configured to adjust or set at least one of:
   an upper limit on the value of the haptic control signal;
   a lower limit on the value of the haptic control signal;
   a relationship between the determined level of ambient vibration and the value of the haptic control signal; and
   a rate at which the value of the haptic control signal is adjusted,
based on at least one of:
   a history of haptic outputs;
   a history of detected user responses to haptic outputs;
   a user setting or system setting;
   a categorisation of the haptic output, optionally wherein the haptic output is configured to have a high-priority categorisation, a low-priority categorisation, a safety-related categorisation, an emergency categorisation, an alert categorisation and/or an informational categorisation; and
   information defining the operational environment of the haptic actuator, such as a characteristic of a user, a time of day, a location, an ambient temperature, an ambient audible noise level, an estimated user distraction level, a type of automobile, a speed, and an acceleration.
S8. The haptic control system of any of the preceding statements, wherein the vibrational information comprises information from one or more vibrational sensors located to sense the ambient vibration and/or information, other than from one or more vibrational sensors, from which the ambient vibration may be estimated,
optionally wherein the haptic control system comprises said one or more vibrational sensors.
S9. The haptic control system of any of the preceding statements, wherein the vibrational information comprises:
   feedback information based on a feedback signal from the haptic actuator, optionally wherein the feedback signal is indicative of a current drawn by the haptic actuator and/or a voltage across the haptic actuator; and/or
   sensor information based on a sensor signal from a vibration sensor other than the haptic actuator; and/or
   external information, indicative of the ambient vibration, from an external data source; and/or
   status information, indicative of the status of at least one vibration source, optionally other than the haptic actuator, operable to contribute to the ambient vibration; and/or
   environmental information, indicative of an aspect of the operational environment of the haptic actuator which affects the ambient vibration, such as location, speed, or acceleration.
S10. The haptic control system of any of the preceding statements, wherein the haptic controller is configured to obtain the vibrational information over time, continuously, intermittently, regularly or irregularly, to track the ambient vibration.
S11. The haptic control system of any of the preceding statements, wherein the haptic controller is configured to update a model based on the obtained vibrational information, the model representative of the operational environment and/or of the level of ambient vibration, and to generate the haptic control signal based on the model.
S12. The haptic control system of any of the preceding statements, wherein the haptic controller is configured to control the value of the haptic control signal, the control comprising:
   adjusting the value of the haptic control signal to tend to keep a difference or ratio between the value of the haptic control signal and the level of ambient vibration above a threshold level, within a target range and/or substantially constant; and/or
   raising the value of the haptic control signal when the level of ambient vibration increases and/or lowering the value of the haptic control signal when the level of ambient vibration decreases; and/or
   setting the value of the haptic control signal at a first level when the vibrational information is indicative of a first level of ambient vibration and setting the value of the haptic control signal at a second level, higher than the first level, when the vibrational information is indicative of a second level of ambient vibration, higher than the first level of ambient vibration; and/or
   controlling the value of the haptic control signal so that the value of the haptic control signal at least partly tracks the level of ambient vibration.
S13. The haptic control system of any of the preceding statements, wherein the haptic controller is configured to:
   compare the level of ambient vibration with a threshold level of ambient vibration; and
   adjust the value of the haptic control signal when the level of ambient vibration is higher than or equal to the threshold level of ambient vibration, and not adjust the value of the haptic control signal when the level of ambient vibration is lower than the threshold level of ambient vibration.
S14. The haptic control system of any of the preceding statements, wherein a higher value of the haptic control signal corresponds to a higher volume (or strength or intensity) or level of the haptic output and a lower value of the haptic control signal corresponds to a lower volume or level of the haptic output.
S15. The haptic control system of any of the preceding statements, wherein:
   the level of ambient vibration comprises a DC component or value of the ambient vibration; and/or
   the vibrational information comprises or is based on a measurement of an instantaneous value or an average or running average of a magnitude, amplitude, peak value, peak-to-peak value, intensity, power or strength, or a DC component thereof, of said ambient vibration.
S16. The haptic control system of any of the preceding statements, comprising:
   a haptic driver configured to drive the haptic actuator with a haptic drive signal based on the haptic control signal,
   wherein the haptic driver is configured to control a level of the haptic drive signal based on the value of the haptic control signal.
S17. The haptic control system of statement S16, wherein controlling the level of the haptic drive signal comprises:
   controlling a gain, wherein the haptic driver is configured to apply the gain to a reference signal, such as by multiplication, to generate the haptic drive signal; and/or
   controlling a compensation signal, wherein the haptic driver is configured to apply the compensation signal to a reference signal, such as by addition or subtraction, to generate the haptic drive signal; and/or
   controlling a level of amplification applied to the haptic drive signal and/or to the reference signal to generate the haptic drive signal; and/or
   controlling a power level of an amplifier used to amplify the haptic drive signal or a signal derived therefrom; and/or
   controlling a power level of the haptic actuator; and/or
   controlling a number of haptic actuators driven by the haptic drive signal, wherein said haptic actuator comprises a plurality of haptic actuators; and/or
   controlling an instantaneous value or an average or running average of a power level or peak-to-peak value, or a DC component thereof, of the haptic drive signal.
S18. The haptic control system of statement S16 or S17, wherein:
   the level of the haptic drive signal comprises a DC component of the haptic drive signal, such as of a power level or peak-to-peak value of the haptic drive signal; and/or
   the haptic drive signal is a sinusoidal signal; and/or
   the level of the haptic drive signal is an instantaneous value or an average or running average of a magnitude, amplitude, peak value, peak-to-peak value, intensity, power, volume level or strength, or a DC component thereof, of the haptic drive signal.
S19. The haptic control system of any of statements S16 to S18, wherein the haptic driver is configured to receive a feedback signal from the haptic actuator, and wherein the vibrational information is based on the feedback signal, optionally wherein the feedback signal is indicative of a current drawn by the haptic actuator and/or a voltage across the haptic actuator.
S20. The haptic control system of any of statements S16 to S19, wherein:
   the haptic controller is provided separately or remotely from the haptic driver, optionally in a separate unit or device or module, and in communication therewith; or
   the haptic controller is integrated with the haptic driver in a single integrated circuit or in a single unit or device or module.
S21. The haptic control system of any of the preceding statements, wherein the ambient vibration comprises background vibration or acceleration in the operational environment of the haptic actuator.
S22. The haptic control system of any of the preceding statements, configured to:
   drive the haptic actuator with the haptic control signal; and/or
   generate a drive signal based on the haptic control signal and drive the haptic actuator with the drive signal.
S23. The haptic control system of any of the preceding statements, configured to control the haptic output in response to a detected user input, optionally a user tactile input, and optionally wherein the haptic output is a function of the user input.
S24. A haptic system comprising:
   the haptic control system of any of the preceding statements: and
   the haptic actuator.
   The haptic system may be configured to drive the haptic actuator with the haptic control signal and/or the haptic drive signal.
S25. The haptic system of statement S24, wherein:
   the haptic actuator is provided separately or remotely from the haptic control system or haptic driver, optionally in a separate unit or device or module, and in communication therewith; or
   the haptic actuator is integrated with the haptic control system or haptic driver in a single haptic unit or device or module.
S26. The haptic system of statement S24 or S25, wherein:
   the vibrational information comprises information from one or more vibrational sensors located to sense the ambient vibration and/or information, other than from one or more vibrational sensors, from which the ambient vibration may be estimated,
   optionally wherein the haptic system comprises said one or more vibrational sensors.
S27. An automobile, an aircraft, a watercraft, a spacecraft, an industrial plant or industrial equipment comprising the haptic control system of any of statements S1 to S23 or the haptic system of statement S24 or S25 or S26.
S28. A haptic control method for controlling a haptic output of a haptic actuator, the haptic control method comprising:
   obtaining vibrational information indicative of a level of ambient vibration in an operational environment of the haptic actuator;
   determining the level of ambient vibration from the vibrational information; and
   generating a haptic control signal for use in controlling the haptic output of the haptic actuator, wherein a value of the haptic control signal is a function of the level of ambient vibration.
S29. A haptic control computer program which, when executed on a computer of a haptic control system, causes the haptic control system to carry out the haptic control method of statement S28.
S30. A (non-transitory) computer-readable storage medium having the haptic control computer program of statement S29 stored thereon.
S31. A method of controlling a haptic actuator, the method comprising:
   obtaining vibrational information indicative of a level of ambient vibration in an operational environment of the haptic actuator;
   determining the level of ambient vibration from the vibrational information; and
   controlling the haptic actuator, wherein a drive signal of the haptic actuator is a function of the level of ambient vibration.
S32. A haptic system, comprising:
   a haptic actuator; and
   a haptic control system configured to:
      obtain vibrational information indicative of a level of ambient vibration in an operational environment of the haptic actuator;
      determine the level of ambient vibration from the vibrational information; and
      control the haptic actuator, wherein a drive signal of the haptic actuator is a function of the level of ambient vibration.
S33. A haptic control system for controlling a haptic output of a haptic actuator, the haptic control system configured to:
   obtain vibrational information indicative of a level of ambient vibration in an operational environment of the haptic actuator;
   determine the level of ambient vibration from the vibrational information; and
   generate a haptic control signal for use in controlling the haptic output of the haptic actuator, wherein a value of the haptic control signal is a function of the level of ambient vibration.
S34. A haptic controller for controlling a haptic signal, the haptic signal for use in driving a haptic actuator, the haptic controller configured to:
   obtain vibrational information indicative of a level of ambient vibration in an operational environment of the haptic actuator;
   determine the level of ambient vibration from the vibrational information; and
   generate the haptic control signal, wherein a value of the haptic control signal is a function of the level of ambient vibration.

### Group A:

A1. An automotive haptic control system for controlling a haptic output of a haptic actuator of an automobile, the haptic control system comprising:
   a haptic controller configured to:
      obtain vibrational information indicative of a level of ambient vibration in an operational environment of the haptic actuator, wherein the operational environment is an automotive environment;
      determine the level of ambient vibration from the vibrational information; and
      generate a haptic control signal for use in controlling the haptic output of the haptic actuator, wherein a value of the haptic control signal is a function of the level of ambient vibration.
A2. The automotive haptic control system of statement A1 or A2, wherein the haptic controller is configured to control the value of the haptic control signal to at least partly compensate for or track a change in the level of ambient vibration.
A3. The automotive haptic control system of any of the preceding statements, wherein:
   the vibrational information comprises prior vibrational information, indicative of the level of ambient vibration prior to said haptic output, the prior vibrational information optionally obtained prior to said haptic output; and/or
   the vibrational information comprises current vibrational information, indicative of the level of ambient vibration during said haptic output, the current vibrational information optionally obtained during said haptic output.
A4. The automotive haptic control system of any of the preceding statements, wherein the haptic controller is configured to adjust or set the function of the level of ambient vibration based on one or more operational factors, such as one or more user-related, usage-related or environmental factors.
A5. The automotive haptic control system of any of the preceding statements, wherein the haptic controller is configured to adjust or set at least one of:
   an upper limit on the value of the haptic control signal;
   a lower limit on the value of the haptic control signal;
   a relationship between the determined level of ambient vibration and the value of the haptic control signal; and
   a rate at which the value of the haptic control signal is adjusted,
based on at least one of:
   a history of haptic outputs;
   a history of detected user responses to haptic outputs;
   a user setting or system setting;
   a categorisation of the haptic output, optionally wherein the haptic output is configured to have a high-priority categorisation, a low-priority categorisation, a safety-related categorisation, an emergency categorisation, an alert categorisation and/or an informational categorisation; and
   information defining the operational environment of the haptic actuator, such as a characteristic of a user, a time of day, a location, an ambient temperature, an ambient audible noise level, an estimated user distraction level, a speed, and an acceleration.
A6. The automotive haptic control system of any of the preceding statements, wherein the vibrational information comprises information from one or more vibrational sensors located to sense the ambient vibration and/or information, other than from one or more vibrational sensors, from which the ambient vibration may be estimated.
A7. The automotive haptic control system of any of the preceding statements, wherein the vibrational information comprises:
   feedback information based on a feedback signal from the haptic actuator, optionally wherein the feedback signal is indicative of a current drawn by the haptic actuator and/or a voltage across the haptic actuator; and/or
   sensor information based on a sensor signal from a vibration sensor other than the haptic actuator; and/or
   external information, indicative of the ambient vibration, from an external data source; and/or
   status information, indicative of the status of at least one vibration source, optionally other than the haptic actuator, operable to contribute to the ambient vibration; and/or
   environmental information, indicative of an aspect of the operational environment of the haptic actuator which affects the ambient vibration.
A8. The automotive haptic control system of any of the preceding statements, wherein the haptic controller is configured to update a model based on the obtained vibrational information, the model representative of the operational environment and/or of the level of ambient vibration, and to generate the haptic control signal based on the model.
A9. The automotive haptic control system of any of the preceding statements, wherein the haptic controller is configured to control the value of the haptic control signal, the control comprising:
   adjusting the value of the haptic control signal to tend to keep a difference or ratio between the value of the haptic control signal and the level of ambient vibration above a threshold level, within a target range and/or substantially constant; and/or
   raising the value of the haptic control signal when the level of ambient vibration increases and/or lowering the value of the haptic control signal when the level of ambient vibration decreases; and/or
   setting the value of the haptic control signal at a first level when the vibrational information is indicative of a first level of ambient vibration and setting the value of the haptic control signal at a second level, higher than the first level, when the vibrational information is indicative of a second level of ambient vibration, higher than the first level of ambient vibration; and/or
   controlling the value of the haptic control signal so that the value of the haptic control signal at least partly tracks the level of ambient vibration.
A10. The automotive haptic control system of any of the preceding statements, wherein the haptic controller is configured to:
   compare the level of ambient vibration with a threshold level of ambient vibration; and
   adjust the value of the haptic control signal when the level of ambient vibration is higher than or equal to the threshold level of ambient vibration, and not adjust the value of the haptic control signal when the level of ambient vibration is lower than the threshold level of ambient vibration.
A11. The automotive haptic control system of any of the preceding statements, comprising:
   a haptic driver configured to drive the haptic actuator with a haptic drive signal based on the haptic control signal,
   wherein the haptic driver is configured to control a level of the haptic drive signal based on the value of the haptic control signal.
A12. The automotive haptic control system of statement A11, wherein controlling the level of the haptic drive signal comprises:
   controlling a gain, wherein the haptic driver is configured to apply the gain to a reference signal, such as by multiplication, to generate the haptic drive signal; and/or
   controlling a compensation signal, wherein the haptic driver is configured to apply the compensation signal to a reference signal, such as by addition or subtraction, to generate the haptic drive signal; and/or
   controlling a level of amplification applied to the haptic drive signal and/or to the reference signal to generate the haptic drive signal; and/or
   controlling a power level of an amplifier used to amplify the haptic drive signal or a signal derived therefrom; and/or
   controlling a power level of the haptic actuator; and/or
   controlling a number of haptic actuators driven by the haptic drive signal, wherein said haptic actuator comprises a plurality of haptic actuators; and/or
   controlling an instantaneous value or an average or running average of a power level or peak-to-peak value, or a DC component thereof, of the haptic drive signal.
A13. The automotive haptic control system of statement A11 or A12, wherein the haptic driver is configured to receive a feedback signal from the haptic actuator, and wherein the vibrational information is based on the feedback signal, optionally wherein the feedback signal is indicative of a current drawn by the haptic actuator and/or a voltage across the haptic actuator.
A14. The automotive haptic control system of any of statements A11 to A13, wherein:
   the haptic controller is provided separately or remotely from the haptic driver, optionally in a separate unit or device or module, and in communication therewith; or
   the haptic controller is integrated with the haptic driver in a single integrated circuit or in a single unit or device or module.
A15. The automotive haptic control system of any of the preceding statements, configured to control the haptic output in response to a detected user input, optionally a user tactile input, and optionally wherein the haptic output is a function of the user input.
A16. An automotive haptic system comprising:
   the automotive haptic control system of any of the preceding statements; and
   the haptic actuator.
A17. An automobile comprising the automotive haptic control system of any of statements A1 to A15 or the automotive haptic system of statement A16.
A18. An automotive haptic control method for controlling a haptic output of a haptic actuator of an automobile, the automotive haptic control method comprising:
   obtaining vibrational information indicative of a level of ambient vibration in an operational environment of the haptic actuator, wherein the operational environment is an automotive environment;
   determining the level of ambient vibration from the vibrational information; and
   generating a haptic control signal for use in controlling the haptic output of the haptic actuator, wherein a value of the haptic control signal is a function of the level of ambient vibration.
A19. An automotive haptic control computer program which, when executed on a computer of a haptic control system of an automobile, causes the automotive haptic control system to carry out the automotive haptic control method of statement A18.
A20. A computer-readable storage medium having the automotive haptic control computer program of statement A19 stored thereon.
A21. An automotive haptic controller for controlling a haptic signal, the haptic signal for use in driving a haptic actuator of an automobile, the automotive haptic controller configured to:
   obtain vibrational information indicative of a level of ambient vibration in an operational environment of the haptic actuator, wherein the operational environment is an automotive environment;
   determine the level of ambient vibration from the vibrational information; and
   generate the haptic control signal, wherein a value of the haptic control signal is a function of the level of ambient vibration.
A22. A method of controlling a haptic actuator of an automobile, the method comprising:
   obtaining vibrational information indicative of a level of ambient vibration in an operational environment of the haptic actuator, wherein the operational environment is an automotive environment;
   determining the level of ambient vibration from the vibrational information; and
   controlling the haptic actuator, wherein a drive signal of the haptic actuator is a function of the level of ambient vibration.
A23. An automotive haptic system, comprising:
   a haptic actuator; and
   a haptic control system configured to:
      obtain vibrational information indicative of a level of ambient vibration in an operational environment of the haptic actuator, wherein the operational environment is an automotive environment;
      determine the level of ambient vibration from the vibrational information; and
      control the haptic actuator, wherein a drive signal of the haptic actuator is a function of the level of ambient vibration.

### Group B:

B1. A control method for use in controlling one or more transducers, comprising: generating, for a haptic event having a haptic output, an audio/visual control signal for at least one audio/visual transducer of the one or more transducers so that at least a corresponding audio or visual output accompanying the haptic output is a function of a level of ambient vibration in an operational environment of the one or more transducers.
B2. The control method of claim B1, wherein at least one of the one or more transducers is a haptic transducer operable to generate the haptic output.
B3. The control method of claim B1 or B2, comprising:
   obtaining vibrational information indicative of the level of ambient vibration; and
   determining the level of ambient vibration from the vibrational information.
B4. The control method of any of the preceding claims, wherein at least one of the one or more transducers is or comprises both a haptic transducer and an audio/visual transducer.
B5. The control method of any of the preceding claims, wherein:
   the at least one audio/visual transducer is an audio transducer operable to generate an audio output but not a visual output, the corresponding audio/visual control signal being an audio control signal; or
   the at least one audio/visual transducer is a visual transducer operable to generate a visual output but not an audio output, the corresponding audio/visual control signal being a visual control signal.
B6. The control method of any of the preceding claims, comprising:
   generating the audio/visual control signal so that at least one of: a presence or absence of the audio or visual output; which audio or visual track is used for the audio or visual output; a duration of the audio or visual output; a frequency of the audio or visual output; a timing of the audio or visual output relative to a timing of the haptic output; and a level of the audio or visual output, is a function of the level of ambient vibration.
B7. The control method of any of the preceding claims, wherein at least two of the transducers are audio/visual transducers operable to generate an audio or visual output, the method comprising generating, for the haptic event, audio/visual control signals for the at least two audio/visual transducers so that:
   which of those transducers generates an audio or visual output is a function of the level of ambient vibration; and/or
   for one or each of those transducers, at least one of: a presence or absence of an audio or visual output; which audio or visual track is used for the audio or visual output; a duration of an audio or visual output; a frequency of an audio or visual output; a timing of an audio or visual output relative to a timing of the haptic output; and a level of an audio or visual output, is a function of the level of ambient vibration.
B8. The control method of any of the preceding claims, comprising:
   generating, for the haptic event, a haptic control signal for a haptic transducer of the one or more transducers so that the haptic output is a function of the level of ambient vibration.
B9. The control method of claim B8, wherein the haptic control signal and the audio/visual control signal are parts of the same transducer control signal.
B10. The control method of claim B8 or B9, wherein the haptic control signal and the audio/visual control signal are configured such that the corresponding haptic output and audio or visual output are one or more of concurrent, synchronised, simultaneous and delayed one from the other by a controlled or defined amount.
B11. The control method of any of claims B8 to B10, comprising:
   generating, for the haptic event, the haptic control signal so that at least one of which haptic track is used for the haptic output, a duration of the haptic output, a frequency of the haptic output, a timing of the haptic output, and a level of the haptic output is a function of the level of ambient vibration.
B12. The control method of any of claims B8 to B11, wherein at least two of the transducers are operable to generate a haptic output, the method comprising generating, for the haptic event, haptic control signals for the at least two haptic transducers so that:
   which of those transducers generates a haptic output is a function of the level of ambient vibration; and/or
   for one or each of those transducers, at least one of: which haptic track is used for a haptic output; a presence or absence of a haptic output; a duration of a haptic output; a frequency of a haptic output; a timing of a haptic output; and a level of a haptic output, is a function of the level of ambient vibration.
B13. The control method of any of the preceding claims, comprising generating one or more said control signal for the haptic event so that, in comparison to output based on a corresponding one or more control signals generated for a lower level of ambient vibration, at least one or at least any two or at least any three of:
   a frequency of the haptic output is lower or higher;
   a duration of the haptic output is longer;
   a level of the haptic output is higher, the same or lower;
   which transducer, or which combination of transducers, is controlled to provide a haptic output is different;
   the audio or visual output is present rather than absent;
   which transducer, or which combination of transducers, is controlled to provide an audio or visual output is different;
   a frequency of the audio or visual output is higher or lower;
   a duration of the audio or visual output is longer; and
   a level of the audio or visual output is the same or higher.
B14. A control method for use in controlling a haptic transducer, comprising:
   generating, for a haptic event having a haptic output generated by the haptic transducer, a haptic control signal for the haptic transducer so that a duration of the haptic output is a function of a level of ambient vibration in an operational environment of the one or more transducers.
B15. The control method of claim B14, comprising generating the haptic control signal so that the duration of the haptic output but not a level of the haptic output is a function of the level of ambient vibration.
B16. A control method for use in controlling a haptic transducer, comprising:
   generating, for a haptic event having a haptic output generated by the haptic transducer, a haptic control signal for the haptic transducer so that a frequency of the haptic output but not a level of the haptic output is a function of a level of ambient vibration in an operational environment of the one or more transducers.
B17. A transducer control system or transducer controller configured to carry out the method of any of the preceding claims.
B18. A transducer system for use in controlling one or more transducers of an automobile, the transducer system comprising:
   the transducer control system or the transducer controller of claim B17; and
   the one or more transducers.
B19. An automobile, an aircraft, a watercraft, a spacecraft, an industrial plant or industrial equipment comprising the transducer control system or the transducer controller of claim B17 or the transducer system of claim B18.
B20. A transducer control computer program which, when executed on a computer of a transducer control system, causes the transducer control system to carry out the control method of any of statements B1 to B16.
B21. A computer-readable storage medium having the transducer control computer program of claim 21 stored thereon.

1. A control method for use in controlling one or more transducers of an automobile, comprising:
generating, for a haptic event having a haptic output, an audio/visual control signal for at least one audio/visual transducer of the one or more transducers so that at least a corresponding audio or visual output accompanying the haptic output is a function of a level of ambient vibration in an operational environment of the one or more transducers,
wherein the operational environment is an automotive environment.

2. The control method of claim 1, wherein at least one of the one or more transducers is a haptic transducer operable to generate the haptic output.

3. The control method of claim 1, comprising:
obtaining vibrational information indicative of the level of ambient vibration; and
determining the level of ambient vibration from the vibrational information.

4. The control method of claim 1, wherein at least one of the one or more transducers is or comprises both a haptic transducer and an audio/visual transducer.

5. The control method of claim 1, wherein:
the at least one audio/visual transducer is an audio transducer operable to generate an audio output but not a visual output, the corresponding audio/visual control signal being an audio control signal; or
the at least one audio/visual transducer is a visual transducer operable to generate a visual output but not an audio output, the corresponding audio/visual control signal being a visual control signal.

6. The control method of claim 1, comprising:
generating the audio/visual control signal so that at least one of: a presence or absence of the audio or visual output; which audio or visual track is used for the audio or visual output; a duration of the audio or visual output; a frequency of the audio or visual output; a timing of the audio or visual output relative to a timing of the haptic output; and a level of the audio or visual output, is a function of the level of ambient vibration.

7. The control method of claim 1, wherein at least two of the transducers are audio/visual transducers operable to generate an audio or visual output, the method comprising generating, for the haptic event, audio/visual control signals for the at least two audio/visual transducers so that:
which of those transducers generates an audio or visual output is a function of the level of ambient vibration; and/or
for one or each of those transducers, at least one of: a presence or absence of an audio or visual output; which audio or visual track is used for the audio or visual output; a duration of an audio or visual output; a frequency of an audio or visual output; a timing of an audio or visual output relative to a timing of the haptic output; and a level of an audio or visual output, is a function of the level of ambient vibration.

8. The control method of claim 1, comprising:
generating, for the haptic event, a haptic control signal for a haptic transducer of the one or more transducers so that the haptic output is a function of the level of ambient vibration.

9. The control method of claim 8, wherein the haptic control signal and the audio/visual control signal are parts of the same transducer control signal.

10. The control method of claim 8, wherein the haptic control signal and the audio/visual control signal are configured such that the corresponding haptic output and audio or visual output are one or more of concurrent, synchronised, simultaneous and delayed one from the other by a controlled or defined amount.

11. The control method of claim 8, comprising:
generating, for the haptic event, the haptic control signal so that at least one of which haptic track is used for the haptic output, a duration of the haptic output, a frequency of the haptic output, a timing of the haptic output, and a level of the haptic output is a function of the level of ambient vibration.

12. The control method of claim 8, wherein at least two of the transducers are operable to generate a haptic output, the method comprising generating, for the haptic event, haptic control signals for the at least two haptic transducers so that:
which of those transducers generates a haptic output is a function of the level of ambient vibration; and/or
for one or each of those transducers, at least one of: which haptic track is used for a haptic output; a presence or absence of a haptic output; a duration of a haptic output; a frequency of a haptic output; a timing of a haptic output; and a level of a haptic output, is a function of the level of ambient vibration.

13. The control method of claim 1, comprising generating one or more said control signal for the haptic event so that, in comparison to output based on a corresponding one or more control signals generated for a lower level of ambient vibration, at least one or at least any two or at least any three of:
a frequency of the haptic output is lower or higher;
a duration of the haptic output is longer;
a level of the haptic output is higher, the same or lower;
which transducer, or which combination of transducers, is controlled to provide a haptic output is different;
the audio or visual output is present rather than absent;
which transducer, or which combination of transducers, is controlled to provide an audio or visual output is different;
a frequency of the audio or visual output is higher or lower;
a duration of the audio or visual output is longer; and
a level of the audio or visual output is the same or higher.

14. A control method for use in controlling a haptic transducer of an automobile, comprising:
generating, for a haptic event having a haptic output generated by the haptic transducer, a haptic control signal for the haptic transducer so that a duration of the haptic output is a function of a level of ambient vibration in an operational environment of the one or more transducers,
wherein the operational environment is an automotive environment.

15. The control method of claim 14, comprising generating the haptic control signal so that the duration of the haptic output but not a level of the haptic output is a function of the level of ambient vibration.

16. A control method for use in controlling a haptic transducer of an automobile, comprising:
generating, for a haptic event having a haptic output generated by the haptic transducer, a haptic control signal for the haptic transducer so that a frequency of the haptic output but not a level of the haptic output is a function of a level of ambient vibration in an operational environment of the one or more transducers,
wherein the operational environment is an automotive environment.

17. A transducer control system or transducer controller configured to carry out the method of claim 1.

18. A transducer system for use in controlling one or more transducers of an automobile, the transducer system comprising:
the transducer control system or the transducer controller of claim 17; and
the one or more transducers.

19. An automobile comprising the transducer control system or the transducer controller of claim 17.

20. A non-transitory computer-readable storage medium having a transducer control computer program stored thereon which, when executed on a computer of a transducer control system of an automobile, causes the transducer control system to carry out the control method of claim 1.
